(19) United States
(12) Patent Application Publication
(10) Pub. No.: US 2009/0287596 A1
(43) Pub. Date: Nov. 19, 2009

(54) Method, System, and Apparatus for Facilitating Transactions Between Sellers and Buyers for Travel Related Services

(76) Inventor: Alex Henriquez Torrenegra, Secaucus, NJ (US)

Correspondence Address: GORDON & JACOBSON, P.C., 60 LONG RIDGE ROAD, SUITE 407, STAMFORD, CT, 06902, US

(21) Appl. No.: 12/174,391

(22) Filed: Jul. 16, 2008

Related U.S. Application Data
(60) Provisional application No. 61/053,247, filed on May 15, 2008.

(51) Int. Cl. G06Q 30/00

(52) U.S. Cl. 705/37; 705/1

(57) ABSTRACT

A method and system for facilitating transactions between sellers and buyers for travel related services. The system includes a database which stores data associated with a plurality of sellers, and a server operably coupled to the database. A buyer interacts with the server to define and submit a request for one or more travel related services. The system uses matching logic to analyze the database to select a set of sellers whose services and other associated data best match the request, and invites the set of sellers to submit offers corresponding to the request. The system communicates offers received by the set of sellers to the buyer and facilitates communications and transactions between the sellers and the buyer.

### CROSS-REFERENCE TO RELATED APPLICATIONS

This application claims benefits from U.S. Provisional Patent Application No. 61/053,247 filed May 15, 2008, the contents of which are hereby incorporated herein by reference in their entirety.

### BACKGROUND OF THE INVENTION

1. Field of the Invention

The invention relates broadly to methods and systems for facilitating electronic commerce. More particularly, this invention relates to methods and systems for enabling buyers to select sellers offering travel related services.

2. State of the Art

The number of ways that a buyer of travel-related services selects a seller or sellers catering to those services has increased over the years, in part because of innovation and advances in technology. Various innovations and advances in technology over the past decade alone have reduced the time required for a buyer to find a suitable seller, decreased the number of sellers who are unable to find a buyer, attracted new travelers, and reduced prices through increased competition. However, in spite of these improvements, price-conscious travelers still need to invest a significant amount of time when looking for travel-related services such as lodgings, flights, car rentals, cruises, etc. Sellers of travel-related services usually have no option but to wait for these travelers to book one or more of their services. In addition, many sellers still have large amounts of inventory that goes unsold, which causes them to lose money. These loses are in turn transferred to the travel-related services and end up being paid by travelers who happen to find a suitable seller. Today's technologies, communication tools, and social networks require more optimal ways of buying and selling travel-related services.

The following includes common methods/technologies currently employed by buyers of travel-related services (such as travel guides and directories, global distribution systems, classifieds, travel search engines, standard online auctions, and conditional-purchase-offer systems) when selecting sellers of those services.

Printed travel guides and directories have existed for more than a century, and typically offer a list of travel services as well as the contact information of the sellers. In some cases, rankings are included. The buyer locates the services of his/her interest in the directories and contacts each seller directly. One of the oldest travel guides is the Official Airline Guide, founded in the United Kingdom in 1853. The first publication of the “Official Aviation Guide Of The Airways” was issued in 1929 in the United States, listing 35 airlines offering a total of 300 flights. Today, many travel guides are available on the Internet. Two of the most popular ones are traveladvisor.com and vrbo.com. Traveladvisor.com covers a wide variety of travel services. VRBO.com specializes in vacation rentals by owner.

Travel guides and directories have a number of disadvantages, including: (a) the need to contact each seller individually to get a custom price quote; (b) the need to contact many sellers if a buyer has a unique need (e.g. a disabled-friendly tour); (c) limited or no access of sellers to prices (or fares) offered by other sellers, thus limiting price competition; (d) possible limited access to published prices, without access to custom offers and prices given by other sellers to one buyer for a given request, which limits quality and price competition, and prevent sellers from directly competing on a buyer's request; (e) wasted time answering buyer requests/inquiries that may be undesirable or already booked by other sellers; (f) price listings resulting from forecasting demand and prices based on previous seasons, which is not optimal because forecasted prices and demand do not always match the actual offer and demand of travel services, thus leading to prices that are too high or too low.

Global Distribution Systems (GDSes) are computerized systems that allow buyers to purchase travel-related services from multiple service providers by offering buyers real time information stored in databases. Arguably, these systems are the most popular way of buying travel-related services nowadays. Online travel agencies such as Expedia.com, Orbitz.com, Hotels.com, and Hotwire.com use GDSes to allow buyers to look for and book travel services.

GDSes evolved from computer reservation systems developed by the air-travel industry. TCA originally developed a computer reservation system in 1953 called ReserVec. It was followed by American Airlines and IBM launching SABRE in 1959. Other computer reservation systems were soon developed: DATAS, Apollo, PARS. These systems were originally exclusive to airline personnel. They were later modified to allow travel agents to use them, and to allow the booking of hotel rooms and rental cars. GDSes became dominant in the travel industry.

GDSes evolved mainly around the unique factors of the air-travel industry, whose factors/requirements may differ significantly from the needs of the other travel-related industries. For example, in the air-travel industry, the number of service providers is usually very small. Most buyers looking for a flight from one city to another will only find a few airlines offering itineraries that fit the needs of the buyer, even when the buyer is willing to buy a flight with several stops. In many cases, only one airline can offer an itinerary that is practical enough for the buyer to consider. By contrast, the lodging industry is highly fragmented. Most cities have thousands of lodging options for a buyer to select. The tour industry provides another example—the high cost and complex logistics of the air-travel industry usually forces most buyers to adjust their schedules to the departure and arrival times of the flights offered by the airlines. Conversely, tour operators may need to adjust their schedules to the individual needs of the buyers.

As a consequence, GDSes usually exclude sellers that do not have the capabilities of maintaining their service prices and availability up-to-date in most of the databases of the GDSes. For example, a small vacation rental owner usually doesn't find it profitable to invest time in adding to the GDS databases the complex algorithms used to determine prices. The same issue applies with respect to the actual availability of the vacation rental unit. As a result, the companies that allow sellers to start offering services in any GDS charge high fees, which further reduces the possibility of small sellers to participate in GDSes. Being primarily owned by airlines, the main interest of GDSes is airline profitability. GDSes are not interested in allowing a high level of competition among the sellers. More competition would bring prices down and force airlines to improve the quality of their service. By way of example, the Justice Department settled a price-fixing suit against American Airlines, Delta, Northwest, Continental, Trans World Airlines, and Alaska Airlines in Mar. 17, 1994. These airlines had agreed to changes in a price information system that was connected to GDSes that were used to increase the cost of airplane tickets by perhaps more than a billion dollars between 1988 and 1992. Earlier, two other airlines settled the case filed by the Justice Department's Antitrust Division. Another issue with GDSes is that other travel industries, such as the lodging industry, have higher levels of competition than the air-travel industry. Currently, there are more lodging options than flight options for a buyer for any given request/itinerary. GDSes, however, force buyers to match their needs with already listed services instead of forcing the seller to adjust his/her services to the unique needs and budgets of each buyer. In other words, sellers cannot directly compete for the request/itinerary of a buyer. In addition, if a buyer requires a custom quote because of a unique need, then the buyer needs to contact each seller individually. In some cases, this is impossible, as the contact information of the seller is not published by GDSes to avoid the buyer from skipping the GDSes when doing a booking (as it would reduce the chances of the GDS getting a commission paid). Some sellers also need to prescreen buyers before allowing the buyer to book a service, such as, for example, owners of luxury vacation rentals. GDSes do not allow sellers to do such prescreening. The prices recorded in the GDS databases usually result from forecasting demand and prices based on previous seasons. This is not optimal as the forecasted prices and demand do not always match the actual offer and demand of travel services. Sellers could easily end up charging too much or too little and not book in full the services they offer.

A classified ad is a form of advertising which is particularly common in newspapers and other periodicals. On the Internet, some websites, such as Craigslist.org, have specialized in being a popular source of classifieds. Classifieds are used by sellers to offer their travel-related services. For example, a tour company may list the tours it offers in the classified section of a local newspaper. A condo owner can offer his/her condo for short-term vacation rental in the local version of craigslist.org. Buyers browse through the classifieds and, if interested, contact the seller. Buyers can also post “wanted” ads in the classifieds. For example, a travelers looking forward to renting a condo for a short period of time in a given city can post his/her need in there and wait for sellers to contact him/her.

Classifieds have several disadvantages: (a) Classifieds are usually temporary, so sellers have to constantly invest time to repost ads; (b) In most cases, the party posting the ad needs to make his/her contact information public, which can result in unwanted solicitations and spam; (c) Since classified systems usually receive ads from many industries, the details of the services posted cannot be easily structured. This lack of structure limits the searching capabilities that can be offered to the buyers. As a consequence, it is usually difficult for buyers to find services that match their unique needs; (d) If the buyer is posting a “wanted” ad, each seller will contact the buyer and submit an offer. As a result, the offers received by the buyer will not share a common structure, thus making it difficult to compare the offers; (e) Because classified systems did not originate as a requirement of the travel industry, they usually do not have procedures in the place that would benefit buyers or sellers, such as, for example, a method to verify the legitimacy of the sellers or the buyers.

A travel search engine is a specialized type of Internet search engine that focuses on travel services. Many have comparison-shopping capabilities that allow visitors to compare prices and options. Most of these sites use technological tools to generate and aggregate results from other travel sites, including third-party travel agency sites such as Expedia.com, Orbitz.com, and Travelocity.com, and branded sites maintained by individual travel companies, such as Delta.com, Hilton.com, or Hertz.com. Kayak.com and Travelzoo.com are widely known travel search engines.

Travel search engines have many disadvantages: (a) They usually aggregate results from sites that depend on GDSes. As a result, all of the issues previously mentioned with respect to GDSes also apply to travel search engines; (b) Travel search engines have a high level of unreliability. They depend on other sites (with whom they usually do not have contractual agreements) to aggregate the results that they present to the buyer. The technology used by travel search engines can fail frequently for many reasons. The buyer, in turn, has a high probability of not receiving accurate prices or not receiving prices at all from many potential sellers; (c) Travel search engines tend to aggregate results from sellers that have a significant inventory of services at different geographical areas. In most cases, it is not profitable to develop the technology to aggregate results from sites of small sellers. As a result, travel search engines tend to exclude small sellers and limit the options visible to those sellers; (d) Travel search engines typically require that buyers contact sellers independently if the buyer needs a custom quote; and (e) Travel search engines do not allow sellers to directly compete for the itinerary of a seller.

Standard online auctions allow participants to bid for products and services over the Internet. The functionality of buying and selling in an auction format is made possible through auction software which regulates the various processes involved. E-Bay, the world's largest on-line auction site, is one of the better known examples. Like most auction companies, eBay does not actually sell goods that it owns itself. Rather, E-Bay merely facilitates the process of listing and displaying goods, bidding on items, and paying for them. It acts as a marketplace for individuals and businesses that use the site to auction off goods and services. Almost all on-line auctions use the English auction method, where the initial price starts low and is increased by successive bidders.

Sellers of travel-related services have frequently auctioned some of their offerings using this model. For example, an airline can auction tickets for some of its low-demand flights. Buyers can submit bids by using their frequent flyer miles or cash. Standard on-line auctions have many drawbacks: (a) The process of an on-line auction is started by the sellers, not the buyer. As such, the chances of having a travel-service for auction that actually matches the needs of a buyer are very low; (b) Price is the only deciding factor, regardless of how desirable the particular buyer might be for the particular seller; (c) Buyers compete for the service, thus forcing buyers to invest a significant amount of time without any assurances that they will submit the winning bid. (d) If the buyer has a specific need that may require a custom price or offer, standard on-line auctions do not allow buyers to get it; (e) Standard online auction sites have garnered a reputation as a place for criminals to unload stolen, diverted, and counterfeit products and services. As a result, many buyers feel discouraged from buying travel services through standard online auctions for fear of losing their money.

U.S. Pat. No. 5,794,207 (filed: Sep. 4, 1996) describes a “Method and apparatus for a cryptographically assisted commercial network system designed to facilitate buyer-driven conditional purchase offers”. This patent is today in use by Priceline.com. At Priceline.com, travelers name their price for airline tickets, hotel rooms, and car rentals. The named price is then compared to undisclosed prices in the Priceline database, with the buyer knowing the location and name of the rental car company, airline, or hotel only after making the purchase.

Conditional-purchase-offer systems have many limitations: (a) The buyer needs to determine a price when posting an itinerary, thus not allowing sellers to compete in terms of pricing; (b) Both the buyer and the seller are unaware of the identity of the other party until after the transaction has been completed, a situation which is especially unfavorable for travel-related services, where the quality and reputation of the service and seller are very important; (c) Because of the above, conditional-purchase-offer systems tend to work only with large chains whose quality levels are generally known to buyers. As a consequence, small sellers are excluded from participating; (d) Conditional-purchase-offer systems rely on already available pricing information provided by the sellers. Thus, sellers cannot directly compete for each itinerary of a buyer; (e) The buyer needs to provide payment information in advance, without any guarantee that a seller will to accept the offer; (f) Conditional-purchase-offer systems do not allow the buyer to receive custom prices or offers from sellers; (g) Some sellers, such as, for example, owners of luxury vacation rentals, need to pre-screen buyers before allowing the buyer to book a service. Priceline.com, in its current embodiment, does not allow sellers to prescreen buyers.

### SUMMARY OF THE INVENTION

The invention provides a method and system for facilitating the selection of sellers offering travel related services. The system includes a database which stores data associated with a plurality of sellers, and a server (e.g., application server) operably coupled to the database. The data associated with the plurality of sellers may include, but is not limited to, the services that each respective seller offers, the specific buyer requests/itineraries to which the respective seller has previously been matched, information related to such requests, the respective seller's previous offers, a profile of the respective seller, contact information for the respective seller, etc. Initially, a buyer interacts with the server over a communication network to define and submit a request for one or more travel related services. The system utilizes matching logic to analyze the database to select a set of sellers from the plurality of sellers that best match the request, and invites the sellers of the set (“invited sellers”) to submit at least one offer corresponding to the request. The invited sellers may submit offers to the server. The system then may communicate to the buyer one or more (or all) offers received at the server. The offer(s) communicated to the buyer can be selected by filtering and/or ranking the offers in order to identify the offer(s) deemed to best match the buyer'request. The buyers, upon receiving the offers from the server, can make their choices based on both qualitative and quantitative factors, such as the extent to which the offer matches the request, the price stated by the offer, quality rankings associated with the particular seller, and numerous other criteria further discussed below. After selecting one or more offers, buyers are either given the option of contacting the seller directly, in which case the system provides the buyer with the identity and contact information of the seller, or given the option of purchasing the service offered by the seller through the system, in which case the system acts as an agent.

These aspects of the invention are expected to promote direct competition among sellers who submit offers based on a given buyer's request, which in turn is expected to improve the quality of the offers and services while reducing their prices. As the system gives sellers access to real time market information, sellers can adjust their offers and prices on a request-by-request basis, a feature that is expected to maximize the prices that a seller can charge at any given time (and thus a seller's competitiveness) while reducing a seller's unsold inventory.

In a second embodiment, the system conducts a bidding process during which the invited sellers are given access to offers submitted by other invited sellers for the given buyer's request. The invited sellers are also notified when one or more invited sellers submit a new offer or modify an existing one for the given buyer's request, thus giving the other invited sellers the option of submitting new or modified offers for the given buyer's request. This bidding process is also expected to further improve the quality and pricing of offers and services by promoting competition among the sellers and giving each seller a second or third bite at the apple based on competing offers.

In a third embodiment, the system's matching logic is adapted to invite sellers sequentially until the buyer receives a predetermined number of offers. The sellers are invited in order of their estimated likelihood of being selected by the buyer. This estimated likelihood is calculated from various likelihood indices or probability factors based on the extent to which the services offered by a particular buyer match a given request, as well as other information contained in the system's database concerning the particular seller and the particular buyer. As a result, buyers are expected to receive a limited number of highly desirable offers and thus reduce the time required to find and select the appropriate seller.

The offer submitted by a given invited seller can be generated by either a human being or by a computer. This feature is expected to attract both small and large sellers. In other embodiments, the buyer has the option of hiding certain information concerning the buyer and/or the buyer's submitted request (such as, for example, the buyer's contact information). In addition, the seller has the option of hiding certain information concerning the seller and/or the seller's submitted offers. This option of selectively hiding certain information is expected to reduce the chances of buyers and sellers receiving spam and/or unsolicited offers. By hiding certain details of submitted offers from other buyers and sellers, sellers can offer prices to specific buyers that are below their published rates while keeping those offers hidden from the public. This feature is expected to reduce the likelihood of other buyers learning of such reduced rates and requesting that the seller honor similar low prices. The feature also allows both sellers and buyers to remain anonymous if they chose to do so due to privacy or any other concerns.

Other embodiments of the invention allow buyers to invite sellers not registered in the system to submit offers. This option is expected to allow buyers to centralize or customize their search while maximizing the number of sellers competing for a given request/itinerary. In addition, a buyer may demonstrate his/her willingness to buy a particular service by depositing money or paying a fee through the system, providing a credit card number, or by submitting a conditional purchase order. The system is configurable to refund the deposit after a successful reservation, purchase, or use of an offered service. This feature is expected to help sellers determine whether or not to submit an offer in response to an invite to bid on a particular request/itinerary. The system may also be configurable to deduct the deposited amount from a commission due to the system by either a buyer or a seller.

It is expected that the method and system of the invention will allow all sellers, large and small, to participate without complex technological infrastructure, and that it will allow buyers to receive offers tailored to their specific needs. The invention is expected to eliminate the need for buyers to contact sellers individually, and to provide a marketplace where buyers can identify and select a seller before agreeing on a purchase, where price is not the only or most important factor in selecting a seller, where the selection and buying process is initiated by the buyer, where buyers can rapidly and easily compare offers received by a multiplicity of sellers given their common structure, and where sellers can proactively lower their prices, improve their offers, and reduce their unsold inventory.

### BRIEF DESCRIPTION OF THE DRAWINGS

FIG. 1 is a schematic of the system of the present invention.

FIG. 1.1 is a block diagram showing the server of the system of FIG. 1.

FIG. 2 is a flow chart illustrating the method of the present invention.

FIG. 2.1 is an illustration of a graphical user interface that allows a seller to register with the system of the present invention.

FIG. 2.2 is an illustration of a graphical user interface that allows a seller to add a service that it offers to the system.

FIG. 2.3 is an illustration of a graphical user interface that allows a buyer to define and submit a request to the system.

FIG. 2.4 is an illustration of a graphical user interface in which the server notifies a seller of a new request and invites the seller to submit at least one offer in response to the request.

FIG. 2.5 is an illustration of a graphical user interface that allows a seller to submit an offer of a service in response to a request.

FIG. 2.6 is an illustration of a graphical user interface in which the server notifies a buyer of a new offer that has been submitted with regard to his/her request.

FIG. 3 is a flow chart illustrating an embodiment of the method of the present invention in which sellers are able to view offers submitted by other sellers regarding a given request and submit new offers for the request.

FIG. 3.1 is an illustration of a graphical user interface in which the sellers are able to view offers submitted by other sellers.

FIG. 3.2 is an illustration of a graphical user interface in which the server notifies a seller of offers submitted by other sellers.

FIG. 3.3 is an illustration of a graphical user interface that allows a seller to view the seller's current offer for a given request and to submit a new offer for the given request.

FIG. 4 is a flow chart illustrating an embodiment of the method of the present invention in which the request posted to the server by the buyer includes the number of offers that the buyer desires for the request.

FIG. 5 is a flow chart illustrating an embodiment of the method of the present invention in which a seller, as part of an offer submitted in response to a given request, may reference a service already listed in the server.

FIG. 5.1 is an illustration of a graphical user interface in which a seller can submit an offer that references a new service.

FIG. 6 is a flow chart illustrating an embodiment of the method of the present invention in which offers are submitted manually by humans or automatically by automated systems.

FIG. 7 is a flow chart illustrating an embodiment of the method of the present invention in which some information of the buyers, sellers, itineraries, and/or services is selectively hidden.

FIG. 8 is an illustration of a graphical user interface in which buyers are able to compare offers received by the server for a given request.

FIG. 9 is a flow chart illustrating an embodiment of the method of the present invention in which buyers are able to buy a service either directly from a seller or through the application server.

FIG. 10 is a flow chart illustrating an embodiment of the method of the present invention in which buyers are able to invite sellers not presently in the system to submit offers in response to a request.

FIG. 10.1 is an illustration of a graphical interface in which a buyer can invite sellers and potential sellers to submit offers.

FIG. 11 is a flow chart illustrating an embodiment of the method of the present invention in which a buyer deposits money to the server to demonstrate his/her willingness to buy a service from the set of offers selected by the system.

FIG. 11.1 is an illustration of a graphical interface in which the buyer can demonstrate his/her willingness to buy a service from the set of sellers selected by the system.

FIG. 12 is a flow chart illustrating an embodiment of the method of the present invention in which a buyer sets filtering rules regarding the minimum qualifications for an acceptable seller, and seller sets filtering rules regarding the minimum qualifications for an acceptable buyer.

FIG. 12.1 is an illustration of a graphical interface in which the sellers set the filtering rules.

### DETAILED DESCRIPTION OF THE INVENTION

The following includes a glossary of terms, which defines terms used herein.

A travel service refers to any service that can be purchased by a buyer to accomplish or make easier a trip or journey. Some types of travel services include air-travel, lodging, car rentals, airport-hotel transportation, long-term parking, tours, cruises, adventures, vacation packages, local activities for tourists, etc.

A buyer is any person or computer system that is attempting to buy a travel service. A buyer could also be an agent acting on behalf of a traveler.

A seller is any person or company that sells or resells travel services. A seller could also be an agent acting on behalf of a person or company that sells or resells travel services.

Sleeping accommodations include, but are not limited to, hotels, motels, vacations rentals, bed & breakfasts, inns, couches, private homes, timeshares, camping grounds, recreational vehicles, marine vehicles (such as boats, cruises, and yachts), airplanes, ground vehicles, etc.

A geographical reference is any piece of information from which at least one geographical location or area can be inferred. Such geographical references include, but are not limited to, the name of a city, a zip code, the code of an airport, the name of an event, the icon of a landmark, a click or series of clicks on a map (latitude, longitude), and an area bounded by a radius from a map click (latitude and longitude). The radius or radial distance may be specified by user input, such as, for example, an inputted actual distance or a time/transportation pairing (e.g., 15 minutes by car).

A request is a set of information including one or more geographical references and one or more dates. A request could also include: preferred and/or required amenities, attractions, and/or services; the number of people in a party, differentiating between the number of children, adults, and seniors; preferred and/or required specific friendly environments, such as, for example environments suited for and allowing pets, smokers, disabled persons, etc; preferred and/or required payment methods; preferred and/or required hotels, service ratings, service ranking, seller reputation level; preferred and/or required room type and/or lodging type; flexibility level regarding preferred dates (e.g., a potentially acceptable arrival date might be two days before or after the preferred arrival date); arrival flight number; and any other information related to a trip or journey.

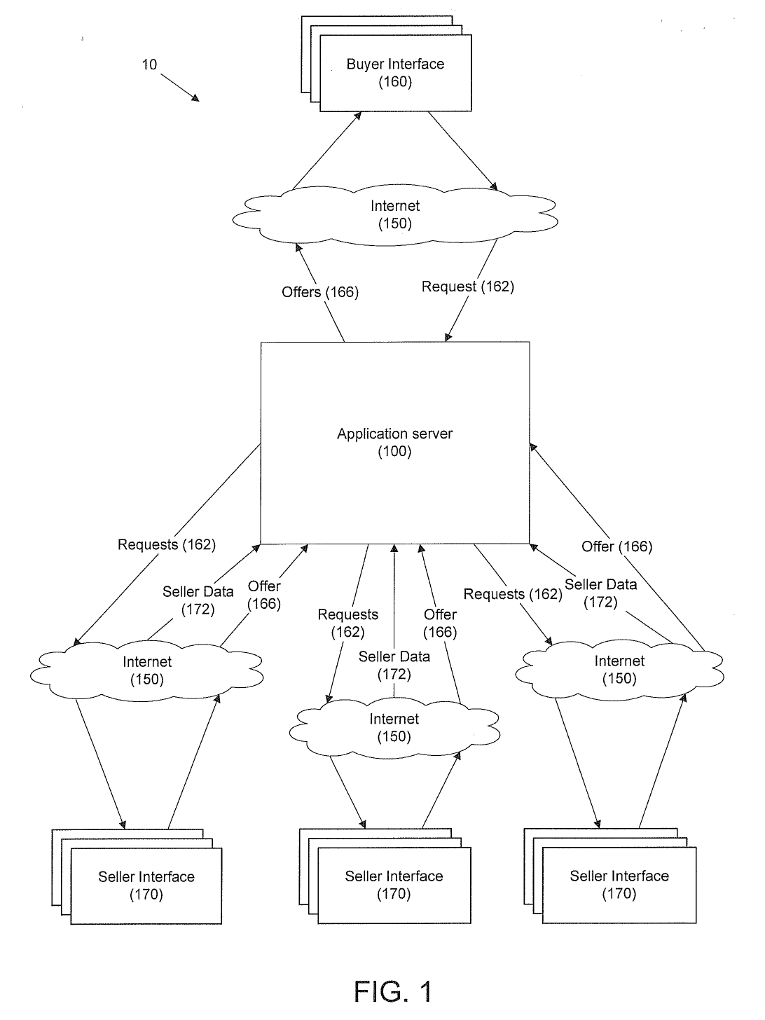

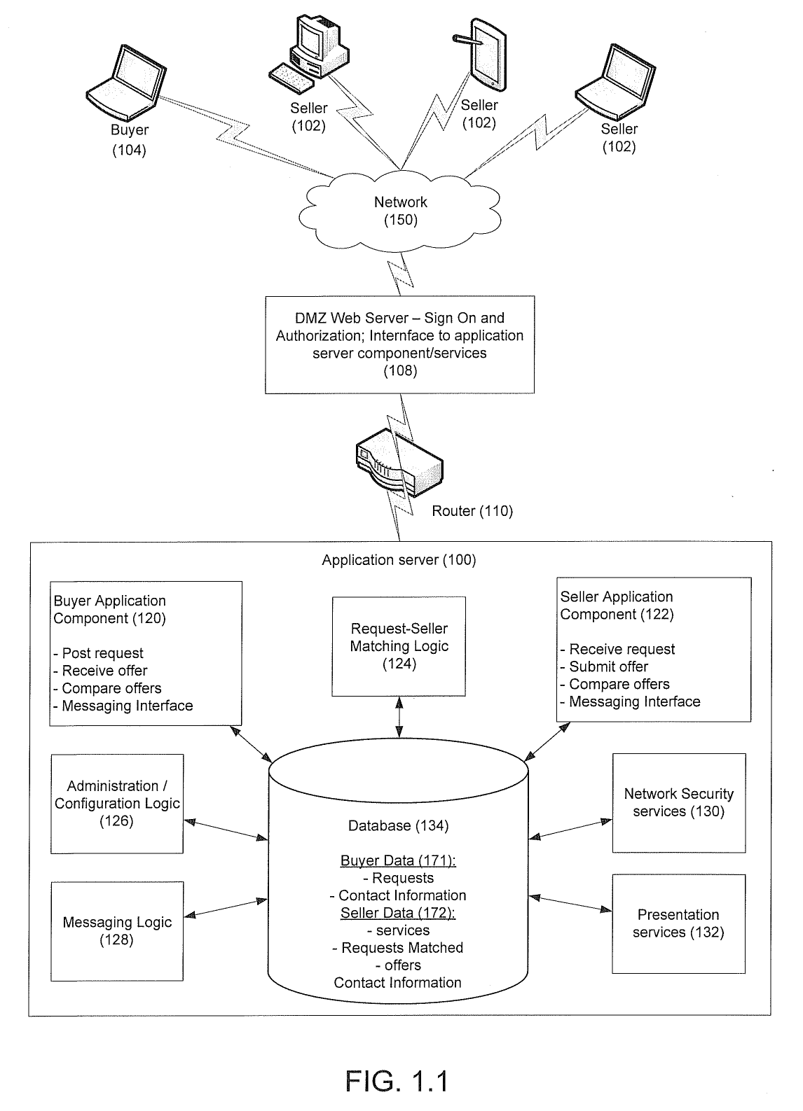

Turning to FIG. 1, shown is the architecture of an electronic commerce system 10 (hereinafter, ‘system’), that facilitates the selection of sellers offering travel-related services. The system includes an application server 100 (hereinafter, ‘server’), buyer interface 160, seller interface 170, the Internet 150, buyer request or itinerary 162 (hereinafter, ‘request’), offers 166, and seller data 172. Two classes of users (denoted “buyers” and “sellers”) use the system 10. At least one buyer accesses the system 10 over a network (such as the Internet) 150 to define and submit a request 162 for one or more travel related services. The system utilizes matching logic (further discussed below) to analyze the seller data 172 to select a set of sellers whose travel related services and other qualifications best match the requirements or preferences of the request 162, obtains offers 166 from the set of sellers, communicates the offers 166 to the buyers, and facilitates travel related transactions therebetween.

FIG. 1.1 shows a block diagram of the server 100 and its interaction with buyers and sellers in more detail. A buyer utilizes a web browser executing on a computing device 104 to connect to a web server 108 over a network such as the Internet 150. Similarly, a number of sellers each utilize a web browser executing on a computing device 102 to connect to the web server 108 over the network 150. Preferably, the browser-based interaction between the computing devices 102, 104 and the web server 108 occur over TCP/IP sessions established therebetween over which are communicated HTML-based (and possibly XML-based) documents and commands, as well as other messages, commands and data. The web server 108 enables login and authentication of the buyer via interaction with the buyer computing device 104, as well as login and authentication of a respective seller via interaction with the seller computing device 102. Such login and authentication can utilize password-based authentication, operating system-based authentication (e.g., NTLM or Kerberos), services-based authentication (e.g., Microsoft Passport authentication), certificate-based authentication, or any other authentication scheme. Once a user session has been authorized (whether a buyer session or a seller session), the web server 108 communicates with the Application Server 100 to build dynamic web page(s) based on data supplied by the Application Server 100, serves the dynamic web page(s) to the buyer web browser (or the seller web browser) as requested, and forwards (and/or transforms) data supplied by the buyer web browser (or the seller web browser) to the Application Server 100 as needed. Preferably, the web server 108 is located in a “demilitarized zone” (DMZ) provided with a firewall router 110. In this configuration, the firewall/router 110 enables authorized communication between the web server 108 and the Application Server 100 (typically utilizing a secure socket layer (SSL) interface or an IPSec interface), while blocking unauthorized communication requests to the Application Server 100. In addition, the web server 108 preferably utilizes style sheets to build the HTML documents (and XML documents) for presentment to the buyer web browser (or to the seller web browse). The web server 108 may be realized by commercially available HTTP servers, such as the Apache Web Server, Microsoft Internet Information Server, and Sun ONE Web Server.

The Application Server 100 includes a Buyer Application Component 120, a Seller Application Component 122, Request-Seller Matching Logic 124, Administration/Configuration Logic 126, a Database 134 storing buyer data 171 and seller data 172, Presentation Services 132, Network Security Services 130, and Messaging Logic/Services 128. The Administration/Configuration Logic 126 provides for system management and configuration of the Application Server 100. The Presentation Services 132 are facilities that enable delivering dynamic content to client browsers. Preferably, the Presentation Services 132 support Active Server Pages, JavaServer pages, server-side scripting such as Perl, CGI, PL/SQL scripting, etc. The Network Security Services 130 provide facilities that maintain network security (such as SSL-based or IPSec-based encryption and authentication facilities). Preferably, the Application Server 100 is realized by a commercially-available software framework, such as the WebLogic Platform commercially available from BEA Systems of San Jose, Calif., the Websphere Application Server commercially available from IBM, Windows Server Systems commercially available from Microsoft Corporation of Redmond, Wash., or the SUN ONE Application Server commercially available from Sun Microsystems of Santa Clara, Calif.

The Database 134 maintains buyer data 171 for each of a plurality of respective buyers and seller data 172 for each of a plurality of respective sellers. The buyer data 171 may include data defining each buyer's submitted itineraries/requests 162, contact information for the buyer, a profile on the respective buyer, etc. The seller data 172 may include data defining the services the seller offers, itineraries/requests to which the respective seller has been matched (i.e., requests for which the seller is invited to submit offers as further discussed below), information related to such requests, offer/request history, a profile of the respective seller, contact information for the respective seller, etc.

The buyer application component 120 of the application server 100 works in conjunction with the presentation services 132 and other components of the application server 100 to provide dynamic content to the web server 108 for delivery to the browser-based buyer computing device 104 as further discussed below. The buyer application component 120 also encodes logic that allows respective buyers to define and submit requests and store information pertaining thereto in the database 134, such as, for example, offers submitted by sellers in response to the buyer's request as well as any other information provided by the seller that relates thereto.

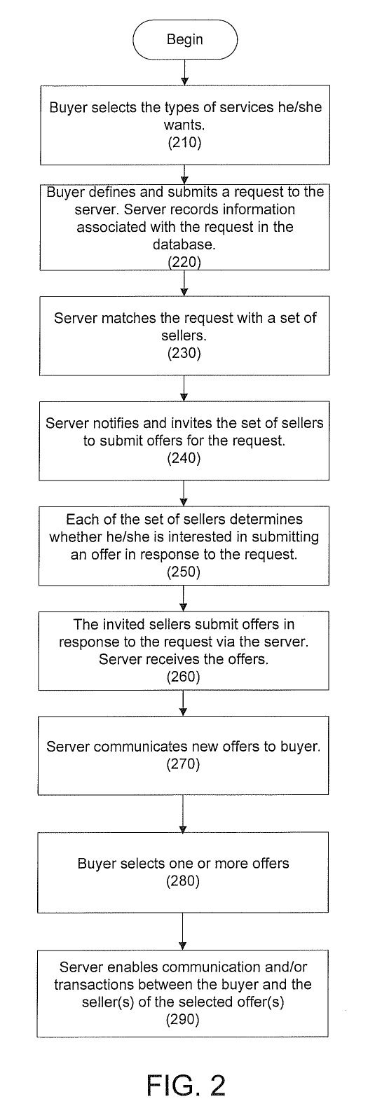

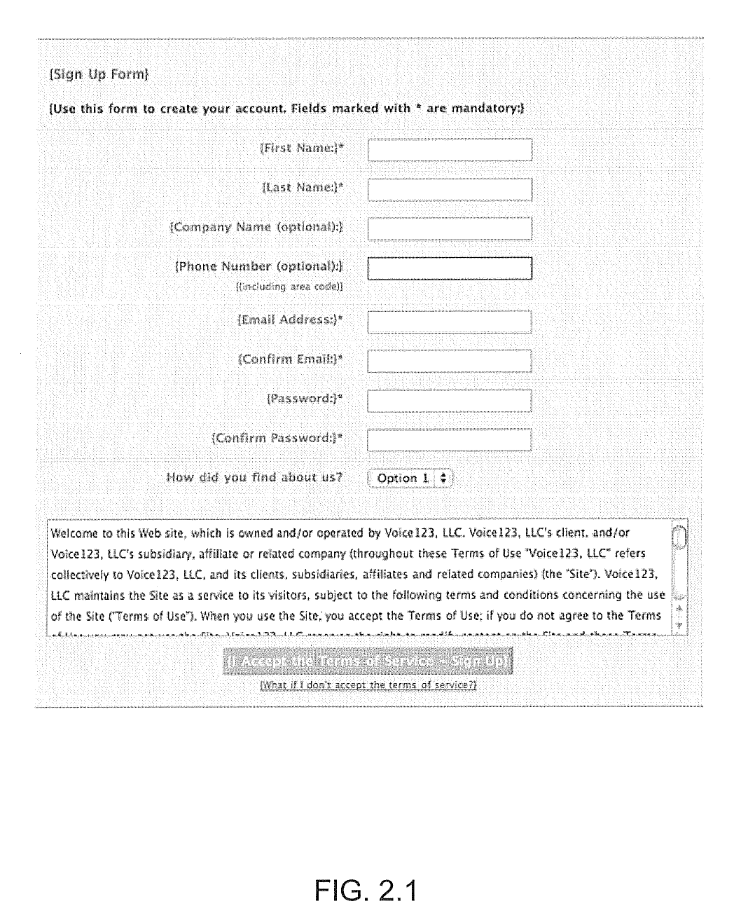

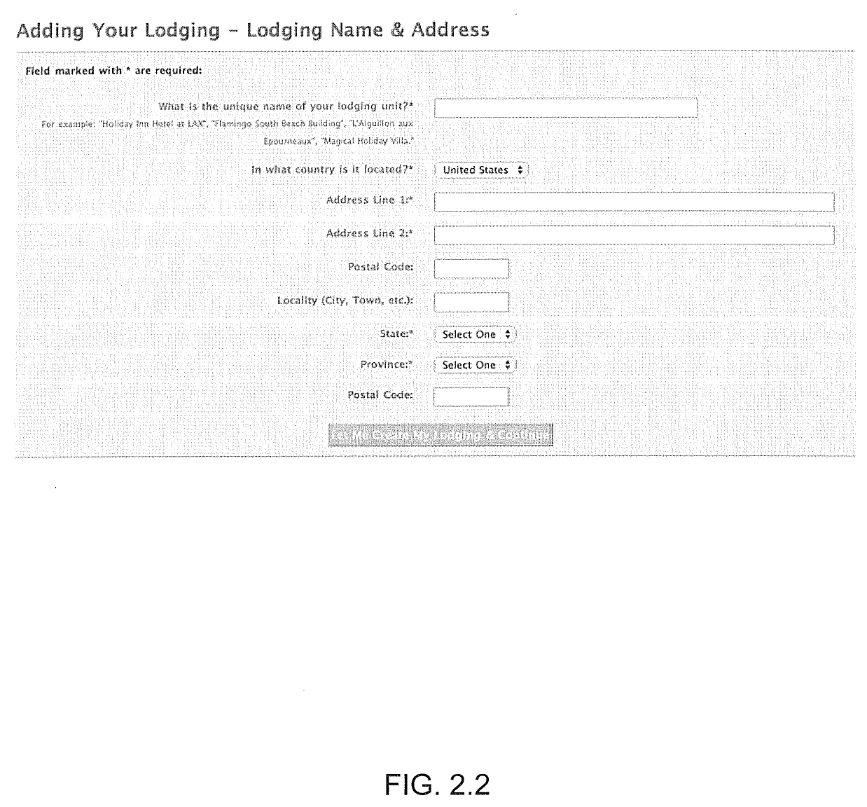

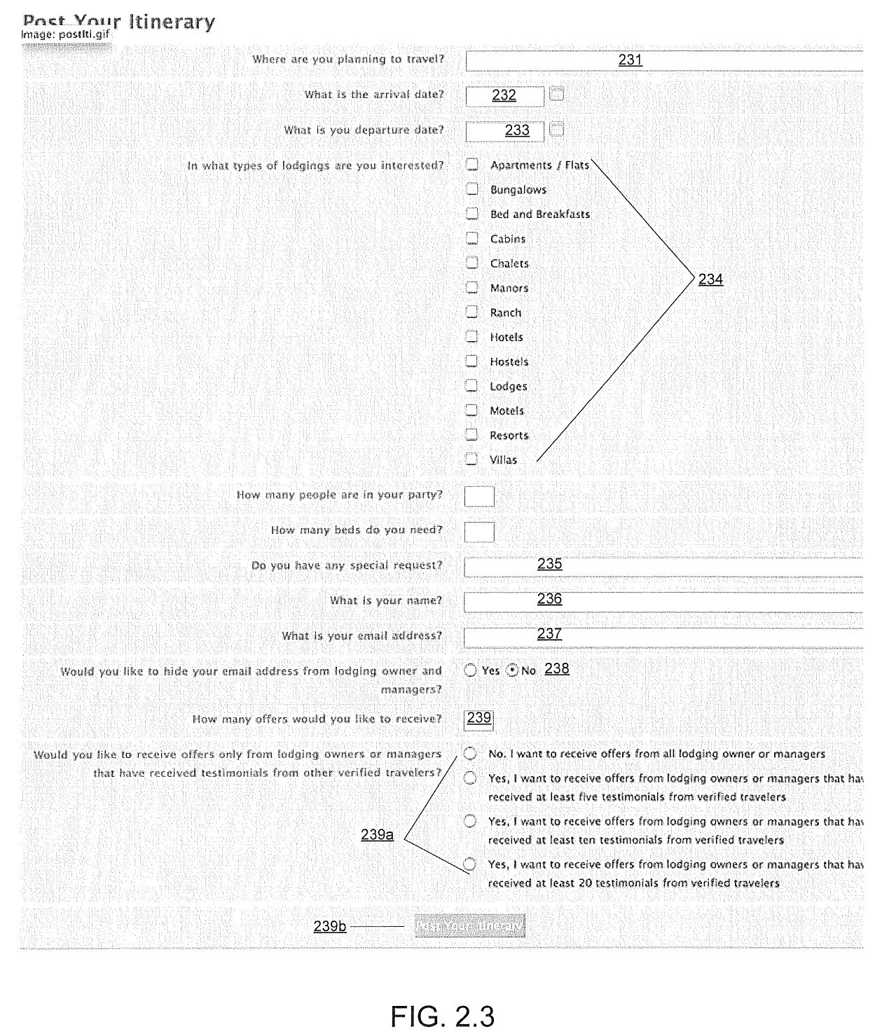

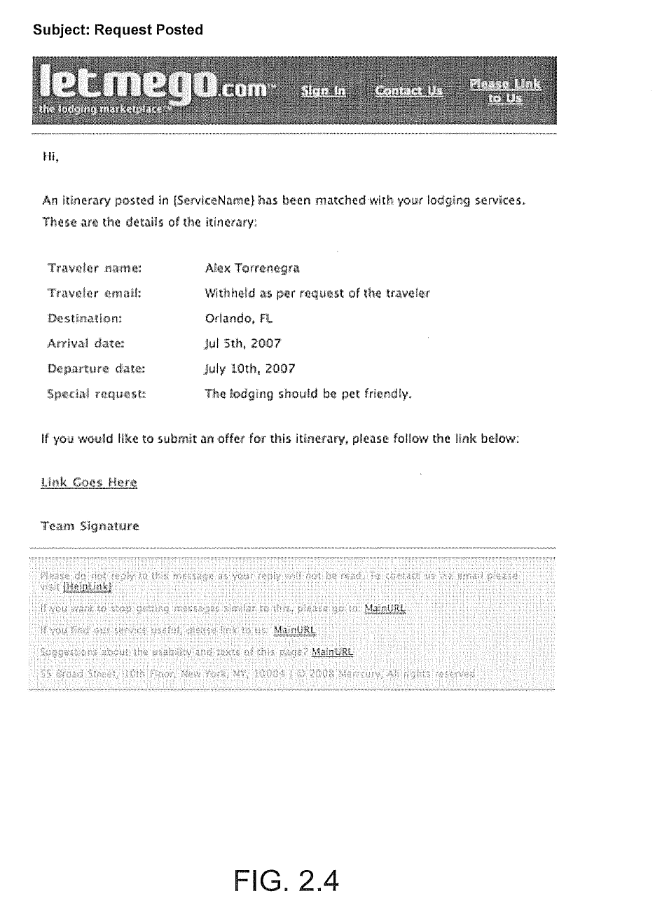

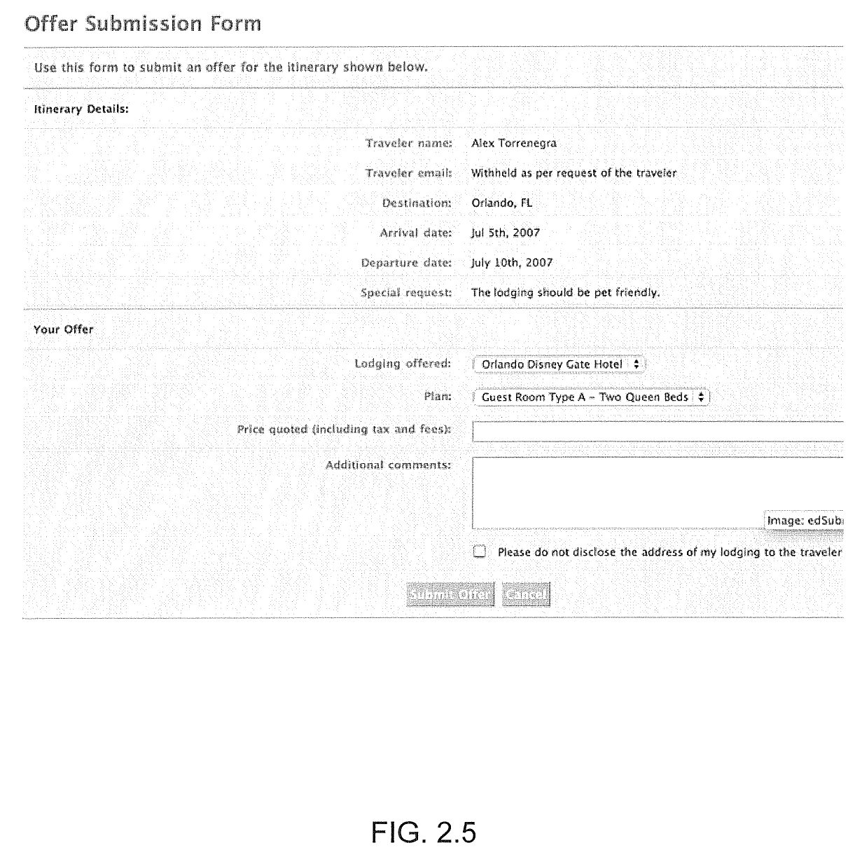

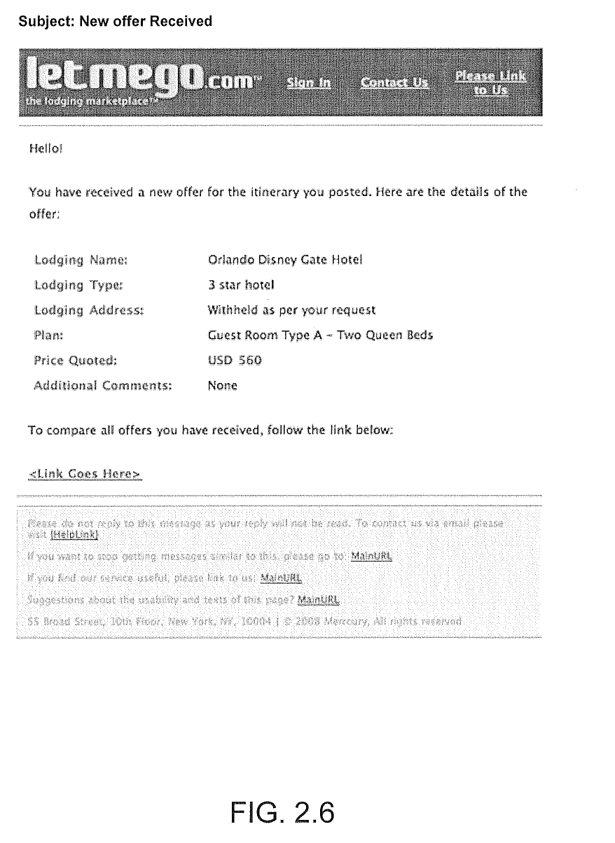

The Seller application component 122 also encodes logic that allows sellers to create and maintain profiles (description of goods or services, rates, availability, pictures, videos, experience, reviews, desired buyer preferences, request matching filter data, etc.), which are stored in the database 134. The seller application component 122 also enables the seller to perform various actions with regard to requests that are matched to the seller (such as creation, submission and management of offers related to a given buyer'request) through user interfaces as further discussed below with respect to FIGS. 2.4-2.6, 3.1-3.3, and 5.1. These user interfaces are communicated to and rendered by the seller and buyer computing devices 102, 104 by operation of a web browser executing on the seller and buyer computing devices 102, 104. Preferably, information is supplied to the database 134 by sellers and buyers using technologies such as HTML and AJAX. However, the system 10 may also be configured to receive information from sellers and buyers via an XML specification, phone calls, faxes, text messages, etc. Information may be inputted either manually or automatically. For example, a travel related service stored in the database 134 with regard to a particular seller may be updated automatically via an XML call. These updates may be done periodically at set times, or in response to the receipt of a request submitted by the buyer or an offer submitted by the seller (further discussed below). Alternatively, updates of seller data may be less specific and performed far less frequently, such as verifying once per year that a seller still offers a particular service stored in the database 134, and prompting the seller to indicate whether it has added any additional services.

Turning to FIG. 2, a flow chart illustrates the method by which the system 10 operates to facilitate transactions for travel related services between buyers and sellers. Initially, at block 210, a buyer interacts with the server 100 over the network 150 to define a request 162 for one or more travel related services. In defining the request 162, the buyer selects at least one category of travel related services represented in the seller data 172 from a list of possible categories. Categories may include air travel, lodging, ground transportation, tours, cruises, vacation packages, etc. After the category is selected, a form is displayed to the buyer through the buyer Interface 160 on the buyer computing device 104. This form contains a number of blank entries and/or selections to be completed by the buyer, each blank entry representing some detail of the request.

At block 220, the buyer completes the blank entries and/or selections of the request and submits the request to the server 100. For example, a business traveler may wish to fly from Washington to New York. The category selected might thus be “air travel,” and the completed entries and selections, which further define the requested service(s), might state “two first-class round-trip tickets between Washington and New York City leaving July 31^{st} and returning August 5^{th}.” The form could contain areas where originating city, destination city, date of the departure, date of return, number of passengers, class of service, and other options are selected, or these items could simply be typed into the black spaces by the buyer. The form could also include an additional area for special instructions, such as, for example, non-stop tickets, an organic meal, a jet aircraft, etc. The buyer simply fills in the blanks, makes the appropriate selections, and submits the request to the server. Preferably, the request includes at least one geographical reference as defined above. The submitted request is then stored in the database 134.

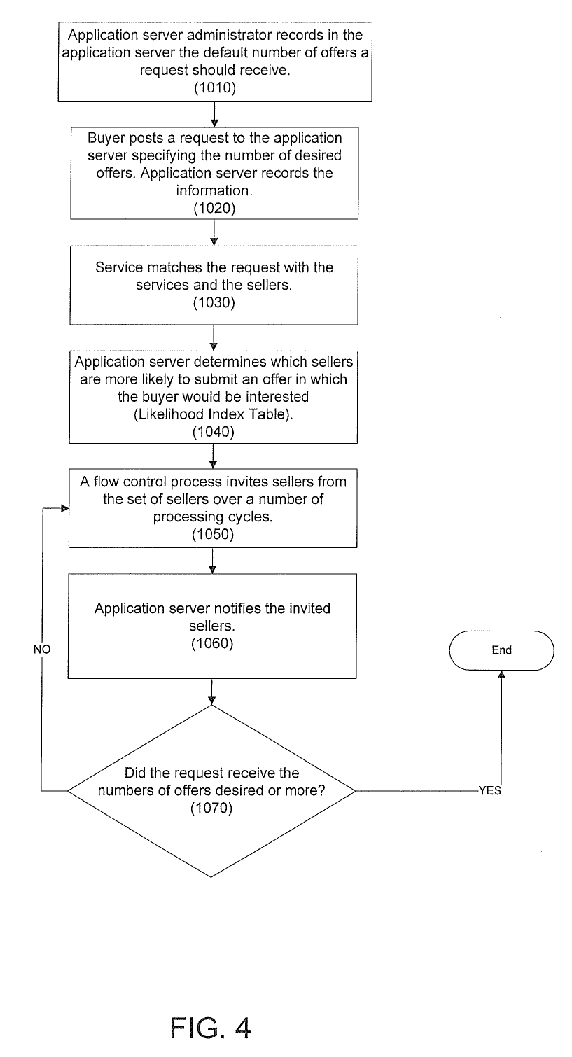

At block 230, the server 100 utilizes matching logic 124 to analyze the seller data 172 to select a set of sellers from the plurality of sellers in the database 134 whose associated seller data 172 includes travel related services and other qualifications that best match the requirements or preferences of the request 162. For example, a traveler might want to stay in any lodging offering private bathrooms in Madrid for two nights starting either July 4^{th} or 5^{th}. The matching logic 124 would match this request against the sellers in the database 134 and likely select a set of sellers having lodgings where private bathrooms are offered (such as, for example, hotels, motels, apartments, bungalows, bed and breakfasts, etc., but not hostels), located in or near Madrid, and having availability for July 4^{th} and 5^{th}, or July 5^{th} and 6^{th}. This matching logic 124 could be configured to be quite rigid (e.g., requiring that a seller's services match all of the requirements of the request), or could be flexible and based on the degree of similarity between the seller's available services and the requirements of the request. A weighted-tree similarity algorithm or other suitable matching algorithm can be used for the matching logic 124. An example of the operations carried out by the matching logic 124 as part of block 230 is discussed below with respect to FIG. 4.

At block 240, the server 100 notifies the set of sellers selected at block 230 that they are invited to submit at least one offer 166 corresponding to the request 162. This notification can be done in several ways. The server 100 can send an e-mail message to each of the set of sellers. The server 100 could also send the invitation by text messages, via cell phone networks, through automated phone calls, faxes, etc. The notification includes details of the request 162 and instructs the buyer on how to retrieve the details of the request 162. For example, the notification might include a link to the web server 108. At this step, the server 100 automatically performs other system 10 tasks related to the request 162, and enables actions and/or tasks to be performed by the sellers and/or the buyer who submitted the request 162. These tasks/actions include, but are not limited to, allowing communication between the invited sellers and the buyer, providing a means for the invited sellers to submit an offer to the buyer, and/or allowing other information exchanges between the invited sellers and the buyer.

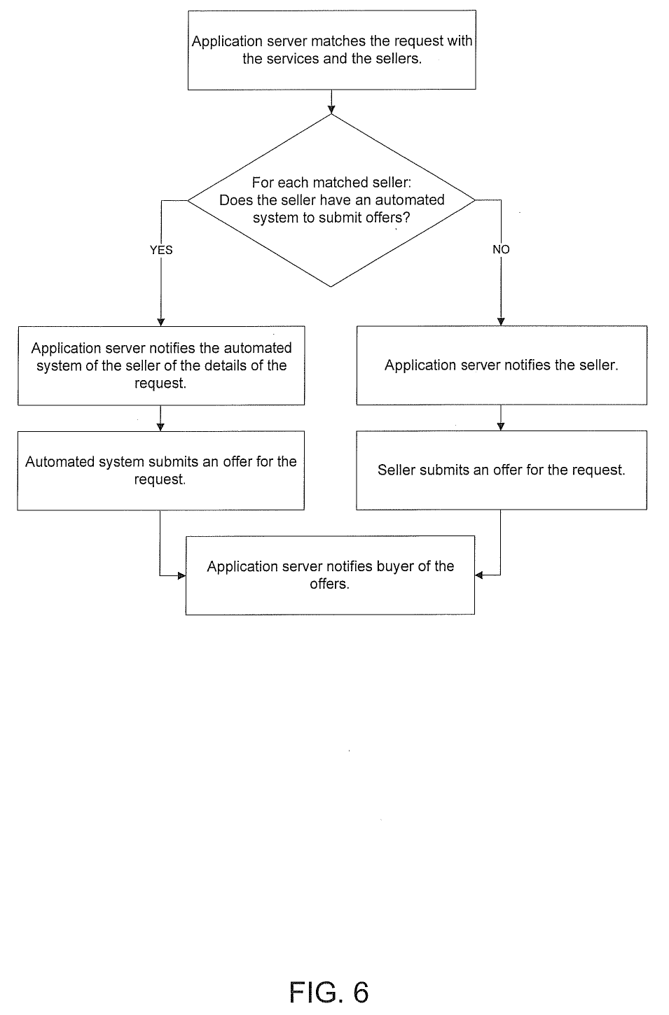

At block 250, each one of the set of sellers invited in 240 (“invited seller”) determines whether or not he/she wants to submit an offer to the buyer of the particular request 162. For example, if one of the selected and invited sellers happens to be an operator or agent of a tour company, then this seller might opt to submit an offer after verifying that there is still availability for his/her tours on the dates requested by the buyer. On the other hand, if one of the invited sellers is the owner of a vacation rental lodging, and the request 162 includes a budget that is well below the minimum rates acceptable to the seller at that particular time, then he or she may opt not to submit an offer. It is anticipated that the decision of whether or not an invited seller submits an offer in response to an invitation sent at step 240 could be an automated one, and done via a computer or computing device. An example of the operations for automated submission of an offer carried out as part of block 250 is discussed below with respect to FIG. 6.

At block 260, the invited sellers who decide to submit an offer in 250 in response to the request 162 enter a description of the offer. In the preferred embodiment, a form is displayed to each seller through the seller interface 170 on the seller computing device 102. This form contains a number of blank entries and/or selections to be completed by the seller, each blank entry and/or selection representing some detail of the offer. For example, a car rental company may want to offer a convertible car for $45.00 per night, including taxes and fees. The description of the offer might include the brand and model of the car and its mileage. The form would include spaces or selections for the price of the service, the brand and model of the car, and the car's mileage. The form would also include spaces for the invited seller to include additional features of the service being offered, such as, for example, the color of the car. The invited seller simply completes the blank entries and submits the offer 166 to the server 100. Alternatively, the form can be generated automatically by the seller computing device 102. For example, the form could be based on a template produced by the seller computing device 102 and communicated to the server 100. The submission of offers via an automated system is further discussed below with respect to FIG. 6. The offer 166 is then stored in the database 134.

At block 270, the system 100 notifies the buyer that he/she has received a new offer in response to the submitted request 162. This notification to the buyer can be done by means of an email message or any other communication method, such as text messages, cell phone messages, automated phone calls, faxes, etc. The notification may include all details of the offer, as well as instructions to the buyer on how to retrieve the details of the offer, such as, for example, providing a link to the web server 108. Such notification can refer to multiple offers received by the server 100 in response to the submitted request 162. The system 100 may communicate to the buyer one or more (or all) offers received at the server. It is also possible that the offer(s) communicated to the buyer can be selected by filtering and/or ranking the offers in order to identify the offer(s) deemed to best match the buyer's request.

At block 280, the buyer selects one or more of the offers communicated in 270.

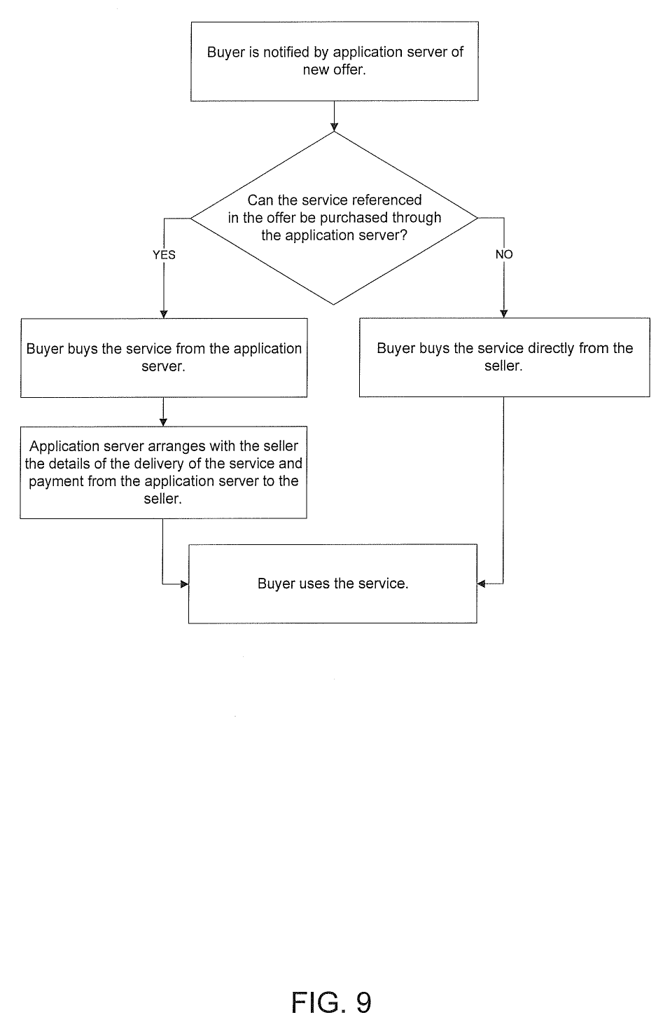

At block 290, the server 100 enables communication and/or transactions between the buyer and the seller(s) of the offer(s) selected in 280. Buyers may be given the option of either contacting the seller directly, in which case the system 10 provides the buyer with the identity and contact information of the seller, or the option of purchasing the service offered by the seller through the system 10, in which case the system acts as an agent. An example of operations that can be carried out as part of block 290 is discussed below with respect to FIG. 9.

This method and embodiment by which the system 10 operates to facilitate transactions for travel related services between buyers and sellers offers a number of advantages. It enables a buyer-driven marketplace to exist without requiring buyers to submit a conditional-purchase offer, as is the case with the only conditional-purchase-offer system known to date—Priceline.com. This method and embodiment also allows buyers to procure offers from small and large sellers in a single marketplace. In addition, this method and embodiment allows buyers to get more and better offers tailored to their specific needs. Thus, the method and embodiment described herein will give the buyer a more attractive, effective, and dynamic means to find sellers of travel-related services than the methods and embodiments known in the prior-art.

FIGS. 2.1-2.6 show illustrations of sample graphical user interfaces for the method and embodiment described above. FIG. 2.1 illustrates a user interface generated by the Seller Application component 122 for allowing a seller to register in the system 10 by adding his/her first name, last name, company name, phone number, email address, and password to the database 134.

FIG. 2.2 illustrates a user interface generated by the seller application component 122 for allowing a seller to add a lodging to the database 134. The interface allows the seller to specify the name of the lodging and its address. A set of additional user interfaces could also be included through which the seller could describe additional details about each lodging.

FIG. 2.3 illustrates a user interface generated by the buyer application component 120 for posting a lodging-related request 162, including a text box 231 for determining where the lodging should be located, text boxes 232 and 233 for specifying the arrival and departure dates respectively, radio buttons 234 for specifying the types of lodgings at which the buyer is willing to stay, text box 235 for specifying any special requests that the buyer might have, text box 236 for entering the buyer's name, text box 237 for providing an email address through which the system 10 will notify the buyer of new offers submitted by sellers for his/her request 162, and a button 239b that is selected by the buyer to commit to storage of the request data in the database 134 of the system.

FIG. 2.4 illustrates a user interface generated by the seller application component 122 for notifying a seller that the seller has been matched to a buyer's request 162 by the matching logic 124 as described herein. The notification is automatically generated by the system 10 and is optionally triggered by the selection of the seller as one of the set of sellers as described herein. The notification allows the seller to view the details of the request 162, including, for example, the name of the buyer, the location requested for the lodging, the arrival date, the departure date, and any special requests. This interface also includes a link to the web server 108 that allows the seller to submit an offer 166 for the particular request 162.

FIG. 2.5 illustrates a user interface generated by the seller application component 122 that allows the seller to define and submit an offer for a lodging-related request to which the seller has been matched. This interface enables the seller to specify a price for the lodging services, and provides other relevant information as shown. The interface also provides detailed information regarding the itinerary as shown. This interface is only presented to the set of sellers who have been selected for the given request 162 as described herein. The form could be displayed to the seller after the seller clicks on the link to the web server 108 that is optionally included in the notification described with respect to FIG. 2.4.

FIG. 2.6 illustrates a user interface generated by the buyer application component 120 for notifying a buyer that he/she has received a new offer 166 in response to that buyer's request 162. The notification may be automatically generated by the system 10 and triggered by the submission of the offer 166 by the seller. The buyer application component 120 works in conjunction with the presentation services 132 and other components of the application server 100 to provide dynamic content to the web server 108 for delivery to the browser-based buyer computing device 104.

The user interfaces of FIGS. 2.1-2.6 are communicated to and rendered by the seller and buyer computing devices 102, 104 by operation of a web browser executing on the seller and buyer computing devices 102, 104. The database 134 maintains a profile for each seller. For example, if a particular seller's travel services focus on lodgings, then the profile for that seller might include the seller's contact information, lodging services offered by the seller, names of the lodgings, pictures of the lodgings, description of the lodgings, the type of the lodgings, the address of the lodgings, the distance from the lodgings to nearby attractions, videos of the lodgings, the rates charged by the seller for the lodgings, any policies enforced by the seller with respect to the lodgings, the availability of the lodgings, reviews on the lodgings, a description of the guest units of the lodgings, any amenities that the lodgings have, historical price data for various requests to which the seller has been matched, any preferences that the seller has regarding potential buyers to whom he or she will submit an offer, and any other data that could be useful for matching the seller to buyers.

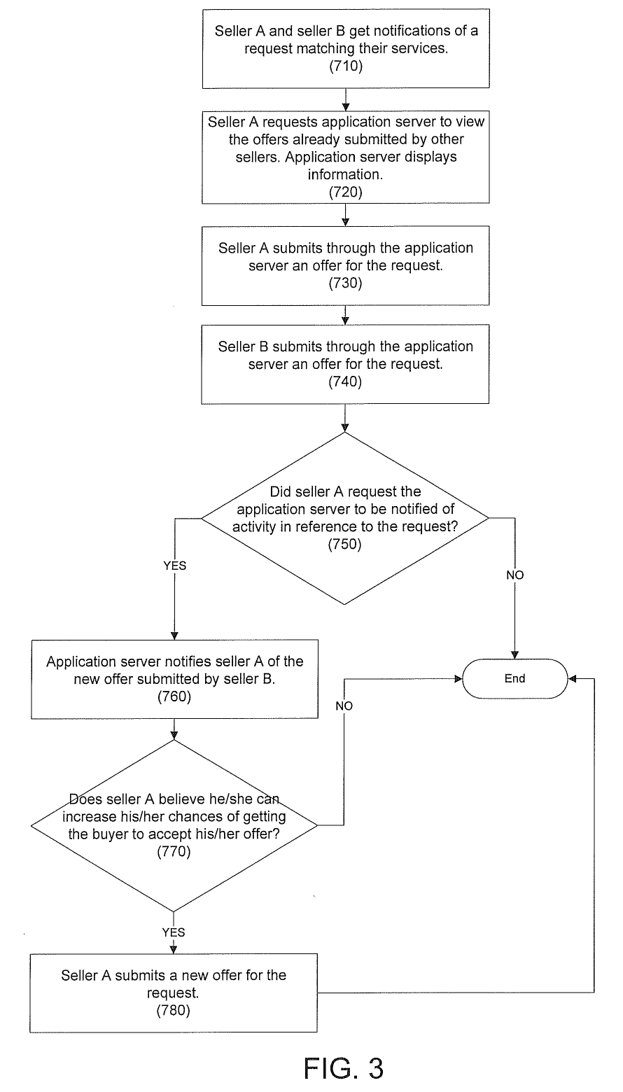

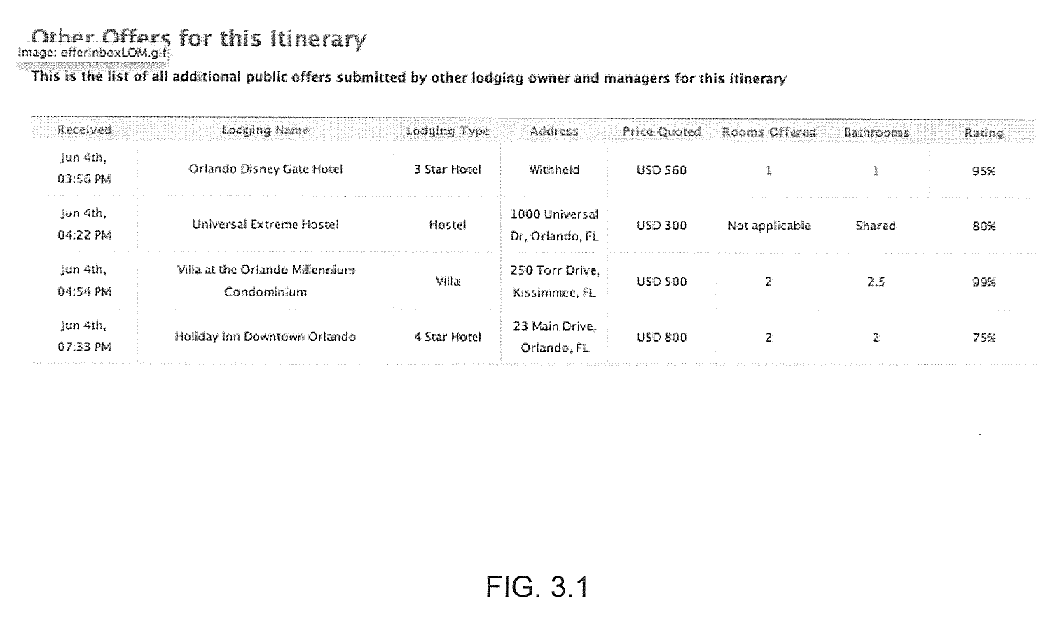

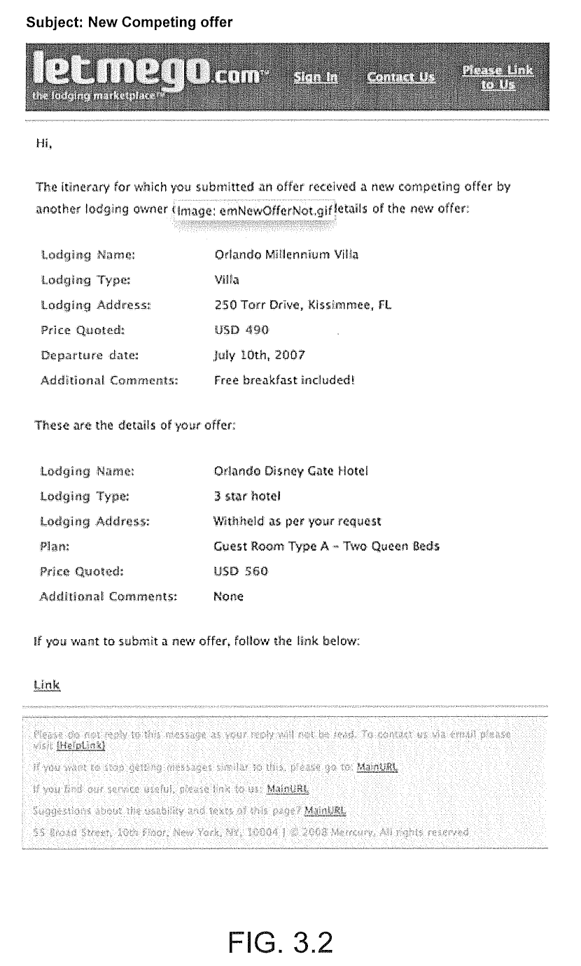

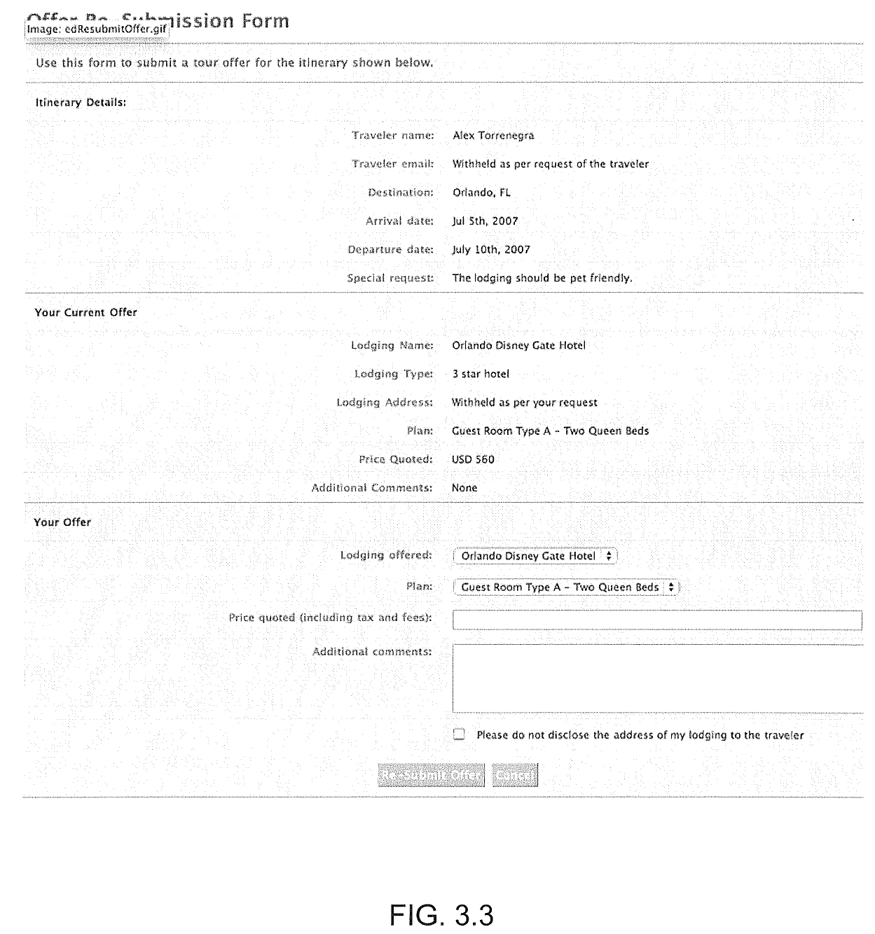

Turning now to FIG. 3, a flow chart of a second embodiment of the method of the present invention is shown in which each one of the invited sellers have access to offers submitted by other invited sellers for the same buyer's request. The invited sellers are notified when an invited seller submits a new offer or modifies an existing one at step 260 of FIG. 2, thus giving the other sellers the option of submitting new or modified offers. This on-line bidding process is expected to further improve the quality and pricing of offers and services by promoting direct competition among the sellers and giving each seller a second or third bite at the apple based on competing offers.

At block 710, two sellers, seller A and seller B, receive notifications that they have been matched to a request 162 by the matching logic 124 as described herein.

At block 720, seller A requests the application server 100, through the web server 108, to show the offers already submitted by other sellers for the request. The seller application component 122 displays to seller A all of the offers submitted thus far by the other invited sellers for to the request.

At block 730, seller A submits an offer for the request. Seller A may also request the application server 100 to notify him/her if any activity occurs with regard to the request, such as, for example, a new offer being submitted by another invited seller.

At block 740, seller B submits an offer for the request.

At block 750, the messaging logic 128 of the application server 100 determines whether or not seller A should be notified of the new offer submitted by seller B. This decision is based on the choices made by seller A at block 730 with regard to viewing other offers.

At block 760, the seller application component 122 notifies seller A of the new offer submitted by seller B.

At block 770, seller A decides whether he/she wants to submit a new offer for the request. Although seller A might have a number of reasons for submitting a new offer, it is likely that seller A will decide to submit a new offer if he/she believes that a new offer would increase his/her chances of being chosen by the buyer.

At block 780, seller A submits a new offer. The entire process illustrated in and described with respect to FIG. 3 could be applied to all of the sellers in the set of sellers invited to submit offers for a given request. This embodiment of the invention is expected to allow sellers to directly compete for the request of a buyer. It is also expected to allow sellers to better adjust their prices based on the current offers and the demands of the market. Additionally, this embodiment is expected to allows buyers to auction off their request without having to commit to purchasing the offer with the lowest price (as is the case of conditional-purchase-offer systems such as Priceline.com). Instead, buyers may place significant weight on other qualitative and quantitative factors when selecting the seller from whom the buyer will buy the requested services.

FIGS. 3.1, 3.2, and 3.3 show illustrations of sample graphical user interfaces for the method and embodiment described with respect to FIG. 3. The user interfaces are communicated to and displayed by the seller computing device 102 by operation of a web browser executing on the seller computing device 102.

FIG. 3.1 illustrates a user interface generated by the seller application component 122 in which an invited seller can view offers that other invited sellers have submitted with respect to a lodging-related request. The interface allows the seller to see when the other offers were submitted, the names of the lodgings offered, the types of lodging offered, the addresses of the lodgings, the prices quoted for each lodging service, the specific rooms and bathrooms being offered, and the rating given by other users (buyers) for each lodging service that is offered. The seller can use this information to determine whether he/she can and wishes to submit a competitive offer for the request, or whether he/she can improve on an offer previously submitted for the request.

FIG. 3.2 illustrates a user interface generated by the seller application component 122 for notifying an invited seller that another invited seller has submitted an offer for a given request. The notification can be automatically generated by the system and triggered by the submission of each new offer received at the server 100 for a given request 162. The notification may also allow the recipient to view the details of the new offer, as well as the details of the offer previously submitted by the recipient of the notification (e.g., the seller's existing offer and the new competing offer can be displayed in the same interface as shown in FIG. 3.2). The interface also optionally includes a link to a web server 108 to give the seller the option of submitting a new offer for the request.

FIG. 3.3 illustrates a user interface generated by the seller application component 122 that allows the seller to create and submit an additional offer for a lodging-related request for which the seller has already submitted an offer. The interface enables the seller to specify a price for the lodging services and provide other relevant information as shown. The interface also provides detailed information regarding the request and previous offer as shown.

Turning to FIG. 4, a flow chart of a third embodiment of the method of the present invention is shown in which the matching logic 124 employed at step 230 of FIG. 2 (in which the server 100 matches a buyer's request with a set of sellers) is adapted to assign sellers a ranking, and the server 100, at step 240 of FIG. 2, invites sellers sequentially until the buyer receives a predetermined number of offers. The pre-determined number of offers to be received for each request may be achieved by an application server administrator via the administration/configuration logic 126, and may be altered by the buyer when the buyer defines and submits the request. The order in which the set of sellers are invited may include a number of different criteria. For example, one objective of the application server 100 could be to first invite the sellers from the set of sellers that have the highest calculated probability of submitting offers that will be the most attractive to the buyer as further discussed below.

At block 1010, an application server administrator 108 interacts with the administration/configuration logic 126 to determine the pre-determined number of offers that should be received at the server 100 for a given request. This value is stored in the database 134, and is used by the buyer application component 120 when displaying the form that allows buyers to define and submit a request. The initial value set by the application server administrator 108 is suggested, by default, to the buyer. Alternatively, the number of offers desired is initially defined via the application server administrator 108.

At block 1020, a buyer inputs the description of the request and the number of offers that he/she would like to receive in response to the request. For example, a business traveler might want to fly from Washington to New York. The description of the request for this service might include several other details, such as the number of offers the buyer wants to receive. After filling out the form(s), the buyer simply submits the request on the system 10, which stores it in the database 134.

At block 1030, a selection process is carried out in which the sellers' profiles and their associated services (which, as discussed above, are stored in the database 134) are matched against the requirements of the submitted request. A set of sellers is thus identified. For example, a vacation traveler might wish to stay in any lodging offering private bathrooms in Madrid for two nights starting either July 4^{th} or 5^{th}. The seller matching logic 124 would then match the request with all sellers in the database 134 that have lodgings where private bathrooms are offered (such as hotels, motels, apartments, bungalows, bed and breakfasts, etc., but not hostels), located in or near Madrid, with availability for July 4^{th} and 5^{th}, or July 5^{th} and 6^{th}. This matching process can be rigid in nature (e.g., requiring that the seller's services match all of the requirements of the request) or can be more flexible, and based on the degree of similarity between a given seller's services and the requirements of the request. A weighted-tree similarity algorithm or other suitable matching algorithm can be used for this matching process.

At block 1040, a likelihood index table (LIT) is built for the identified sellers selected in block 1020. The LIT includes a likelihood index or relevancy index (LI) for each identified seller. The LI represents the likelihood (or probability) that an offer from the identified seller will best match the buyer's request. The LI can also account for the level of activity of sellers in the marketplace and/or numerous other factors, each of which is accorded a different weight based on an individual buyer's needs. Different travel services will likely require different factors to use in the calculation, and a buyer can assign relative weights to the various factors if desired. The seller from the set of sellers with the highest LI is deemed to have the greatest chance of submitting an offer that the buyer will accept. The LIT assigns a rank to each of the set of sellers by their LIs from highest LI to lowest LI. The seller(s) having the highest LI are ranked first in the LIT and the seller(s) with the lowest LI are ranked last in the LIT.

In addition, the LI could be configured to factor in the amount of commission, if any, that, when signing up with the system 10, a particular seller agreed to pay in exchange for being notified of a particular buyer's request. The payment of such a commission by the seller to the system 10 might also be contingent on the buyer accepting one or more of the seller's offers. While high commissions to the system 10 may effect a seller's profits on a particular offer, such a feature could allow relatively new and/or unknown sellers a chance to receive more invitations and possibly create contacts or relationships with buyers in the system 10. It is anticipated, however, that the primary weighted factors of the LI will be the specific services offered by the seller, and the extent to which those services match the needs of a given buyer as indicated by a particular request, though this decision ultimately falls within the province of the system owner.

At block 1050, a flow control process (FCP) is carried out to regulate the process and flow by which the buyer receives offers from the set of sellers selected for the request. The FCP is intended to increase the buyer's chances of getting offers from the best matching sellers for the request at the beginning of the process. The FCP invites sellers in the set of sellers in order of their ranking over a number of processing cycles. In each processing cycle, the FCP invites a new number of sellers in the set of sellers to invite. The number of invited sellers and the time period calculated for each processing cycle is strategically determined to make the most efficient use of the buyer's time in finding a seller for a project.

At block 1060, the server 100 invites a new number of sellers from the set of sellers to submit an offer for the itinerary.

At block 1070, the configuration logic 126, at the end of a predetermined time period after the invitation of the new number of sellers at block 1060, determines whether the server 100 has received the pre-determined number of offers for the request. If not, then the system 10 returns to block 1050 to continue the FCP process. If the pre-determined number of offers have been received, then the system 10 can automatically perform various system tasks related to the request before processing the offers. It is contemplated that if all of the set of sellers are invited to submit offers and the number of offers received at the server is less than the pre-determined number of offers desired, then the system 10 will select a new set of sellers from the database and repeat the process at block 1050.

It is anticipated that this embodiment of the method of the invention will allow buyers to obtain a limited number of highly desirable offers in a short time period. Additionally, it is anticipated that this embodiment will allow buyers to get more and better offers tailored to their specific needs than existing solutions, thus offering the buyer a more attractive, effective, and dynamic way to find sellers of travel-related services than the prior-art allows.

Other embodiments are contemplated in which invited sellers are allowed to initially submit more than one offer. For example, in response to a lodging-related request, an invited seller could submit an offer for each lodging unit or location that he/she manages (assuming that such units and/or locations are in close proximity to or within the geographic reference indicated by the buyer in the request). In response to a tour-related request, a tour-guide could submit an offer for each type of tour that he/she offers. An airline could submit an offer corresponding to each seat class (coach, business, first, etc.). Additionally, embodiments are contemplated in which an invited seller could include two or more services in the same offer. For example, an airline could submit one offer for a travel-related request that includes different prices for each seat class (coach, business, first, etc.).

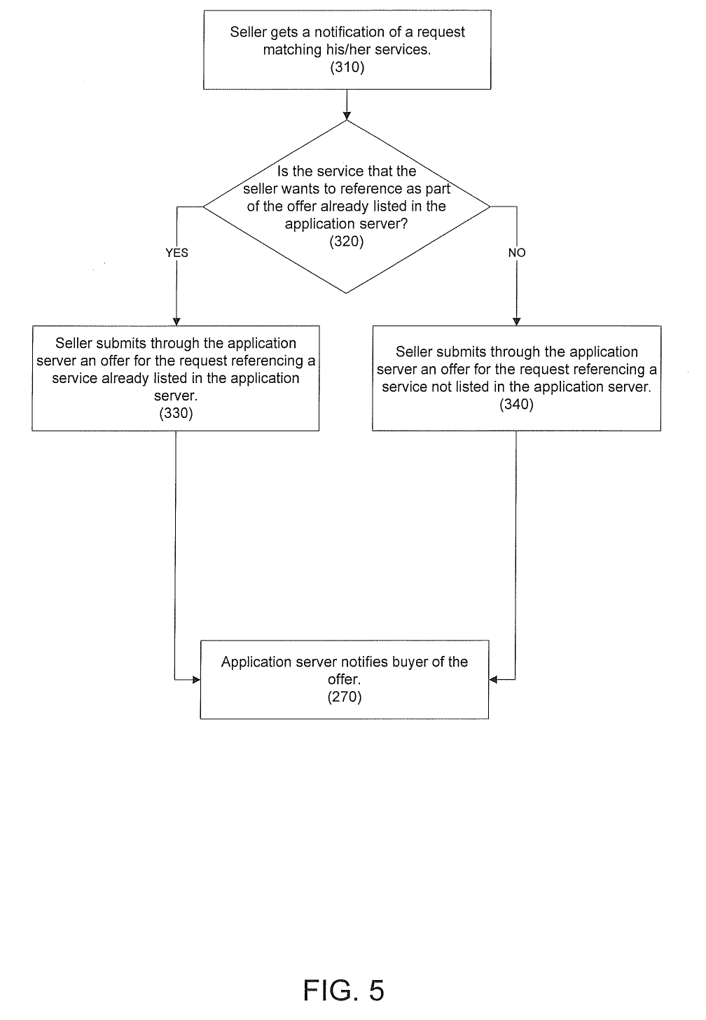

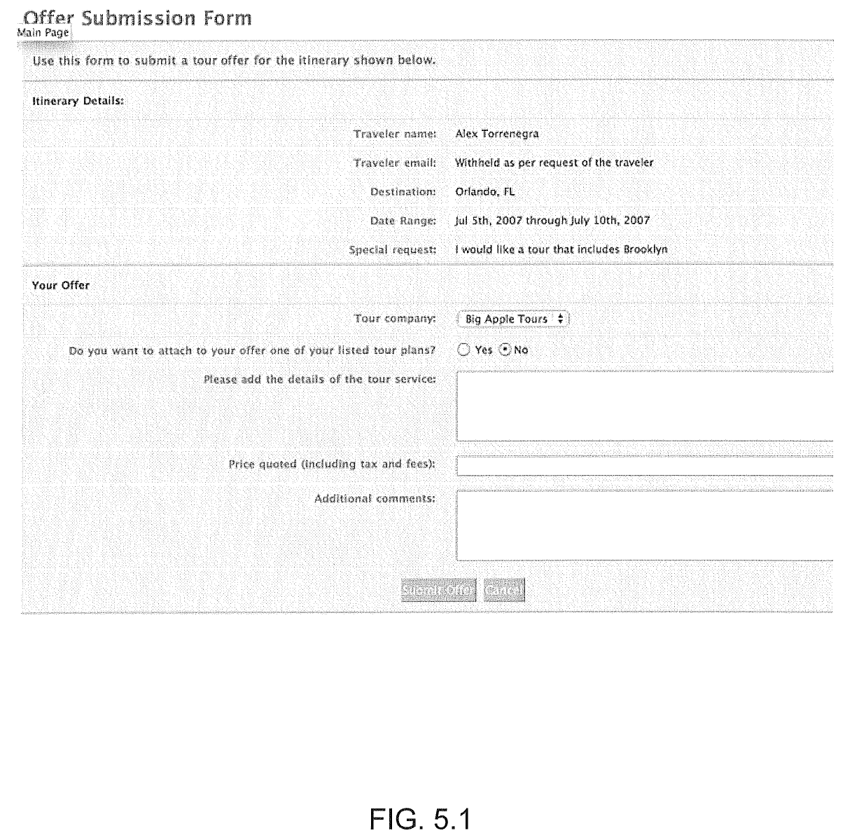

Turning to FIG. 5, a flow chart of a fourth embodiment of the method of the present invention is shown in which, at step 260 of FIG. 2, invited sellers link to offers for services already listed in the database 134 that they submitted for other requests. Alternatively, sellers may submit an offer referencing a service not listed in the database 134.

At block 310, a seller receives a notification from the application server 100 inviting him/her to submit an offer in response to a request.

At block 320, the seller determines whether the services he/she wants to include as part of the offer are already listed in the database 134. For example, if a buyer submits a request for two airline tickets having up to two stops from Oklahoma to Toronto, then the matching logic 124 may determine that a specific airline should be invited to submit an offer because the database 134 has recorded that that specific airline offers direct flights from Oklahoma to Toronto. The seller may reference this service in a new offer or reference a service not listed on the server.

At block 330, the invited seller submits an offer in response to the request. The offer references a service already recorded in database 134, such as the non-stop flight from Oklahoma to Toronto referred to above.

At block 340, the invited seller submits an offer in response to the request. The offer links to a new service not previously recorded in database 134. It is also contemplated that a seller could provide sufficient information about a new service to record it in the database 134 for future use.

FIG. 5.1 illustrates a user interface generated by the seller application component 122 in which an invited seller creates and submits an offer for a tour-related request. The offer can link to an existing tour service recorded in the database 134 or to a tour service that was not previously contained in the database 134. The interface also provides detailed information regarding the request.

Turning to FIG. 6, a flow chart of a fifth embodiment of the method of the present invention is shown in which, at step 260 of FIG. 2, a seller may submit an offer himself/herself or have one submitted on his/her behalf by an automated system. If generated by an automated system, the offer may be generated upon receipt of the invitation by the server 100. The transfer of the notification from the application server 100 to the automated system (or vice versa) could be acheived using standard protocols such as XML or web services. It is anticipated that this embodiment will allow small sellers to better compete with large sellers without having to afford the technological infrastructure that large sellers have. In addition, it is anticipated that buyers will be able to get better offers from small and large sellers in a single marketplace using a single interface. Thus, the buyer will have a more attractive, effective, and dynamic way to find sellers of travel-related services than the prior-art presently allows.

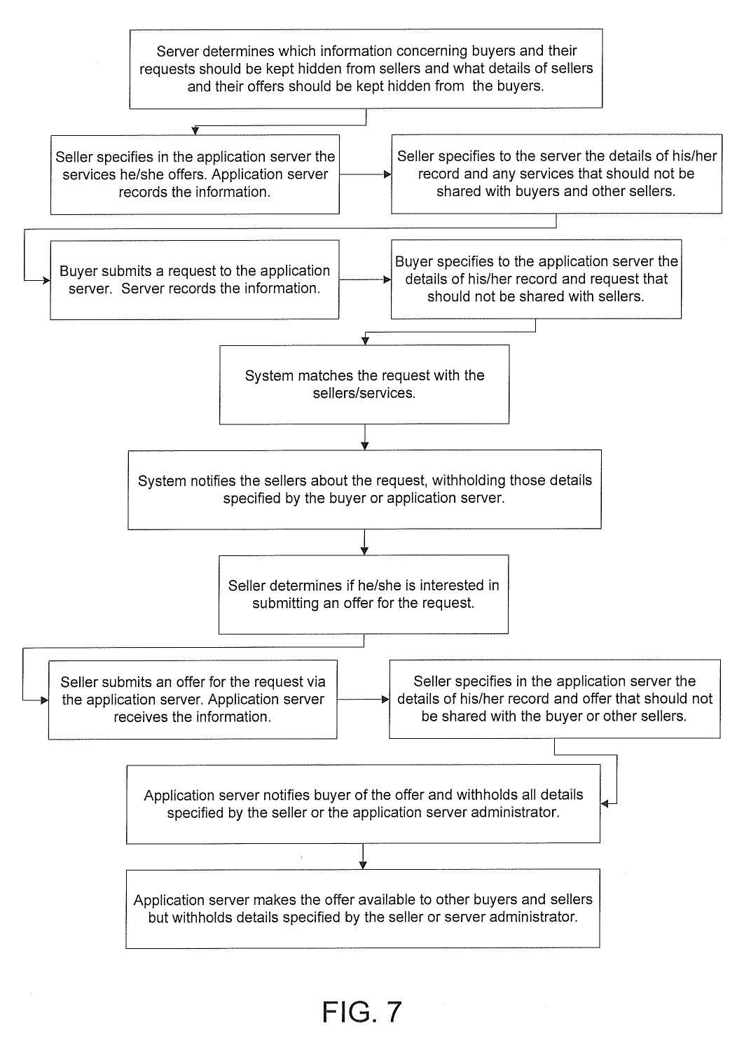

Turning to FIG. 7, a flow chart of a sixth embodiment of the method of the present invention is shown in which, at steps 240, 270, 280, and possibly 290 of FIG. 2, the buyer's contact information, the seller's contact information, and various pieces of information in the buyer's request and/or the seller's offer are optionally hidden from the respective buyers and sellers to whom the requests and offers are forwarded. This embodiment allows both buyers and sellers to participate in a marketplace while remaining anonymous.

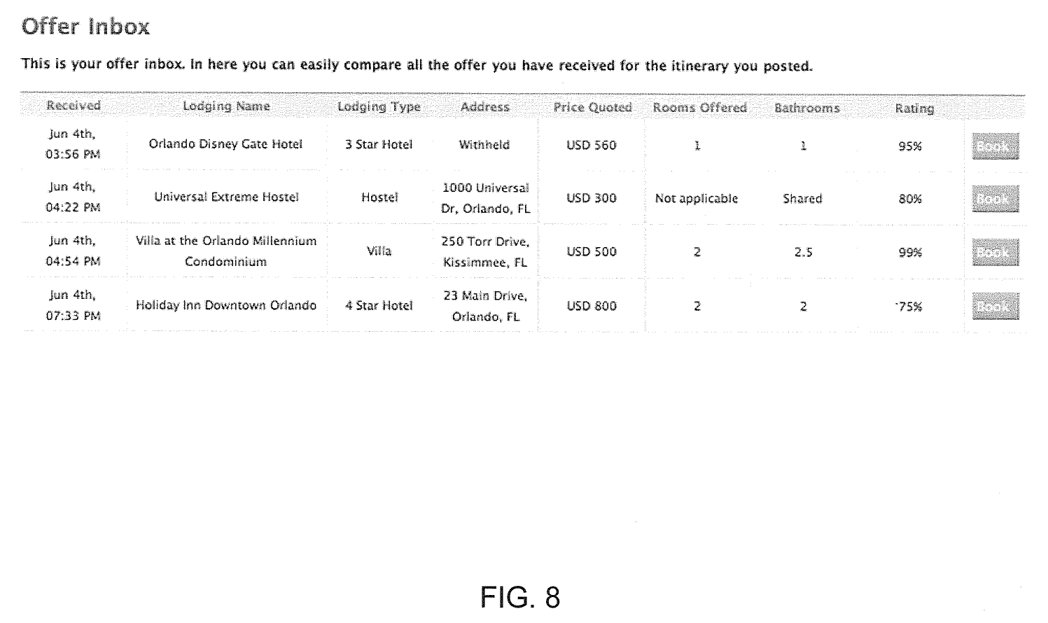

FIG. 8 illustrates a user interface generated by the buyer application component 120 for a buyer to view and compare the offers he/she has received at step 270 of FIG. 2 for a lodging-related request. The interface includes the same information as that included in the interface illustrated in FIG. 3.1, but also contains a link to a web server 108 that enables the buyer to book the service linked with of any of the offers. This embodiment allows buyers to compare offers from small and large sellers in a single marketplace and interface.

FIGS. 9-12.1 show additional contemplated embodiments and features of the present invention. The flow chart of FIG. 9 depicts an embodiment of the method of the invention in which the buyer, after receiving one or more offers for a given request and selecting one or more of these offers (steps 270 and 280 of FIG. 2), has the option, at step 290 of FIG. 2, of either buying the offered service(s) directly from the seller or buying the service(s) from the system 10 through the application server 100. It is anticipated that allowing these two options will attract two types of buyers—those who wish to avoid “middlemen,” and those who wish to buy through a reputable middleman or agent. In the embodiments discussed above, the server 10 may also enable communication between sellers and buyers prior to any offers being submitted for a particular request, particularly if buyers have questions for a particular seller or vice versa.

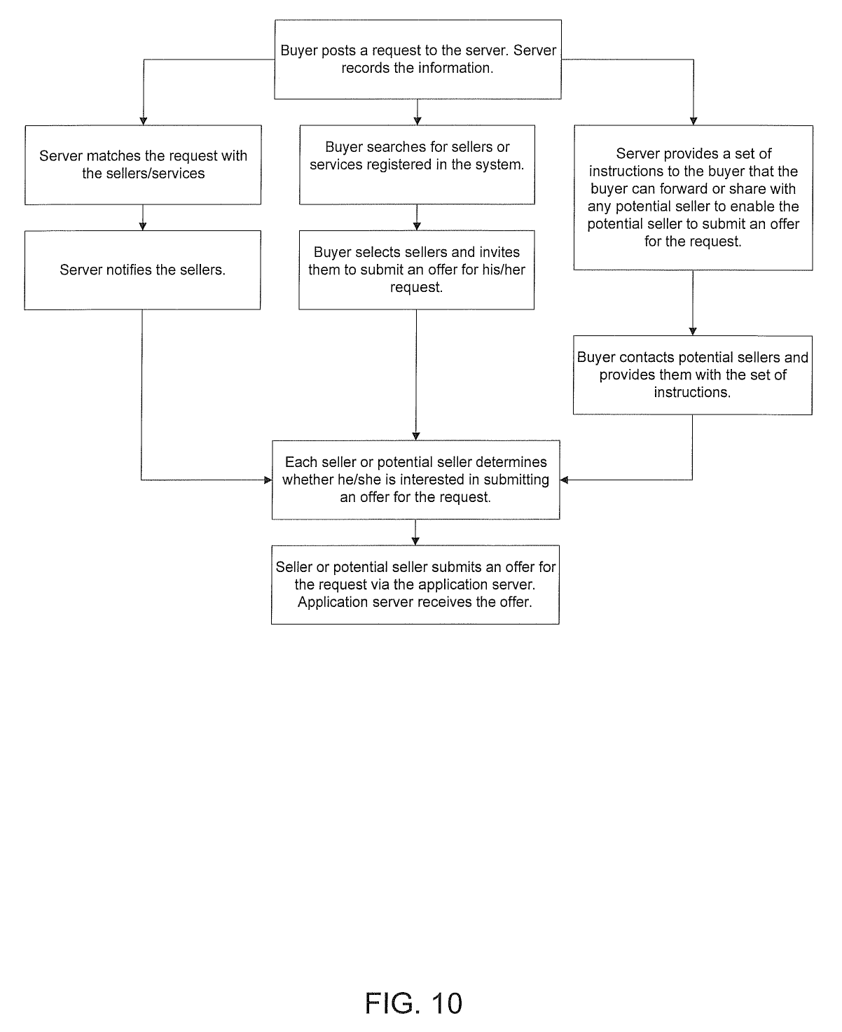

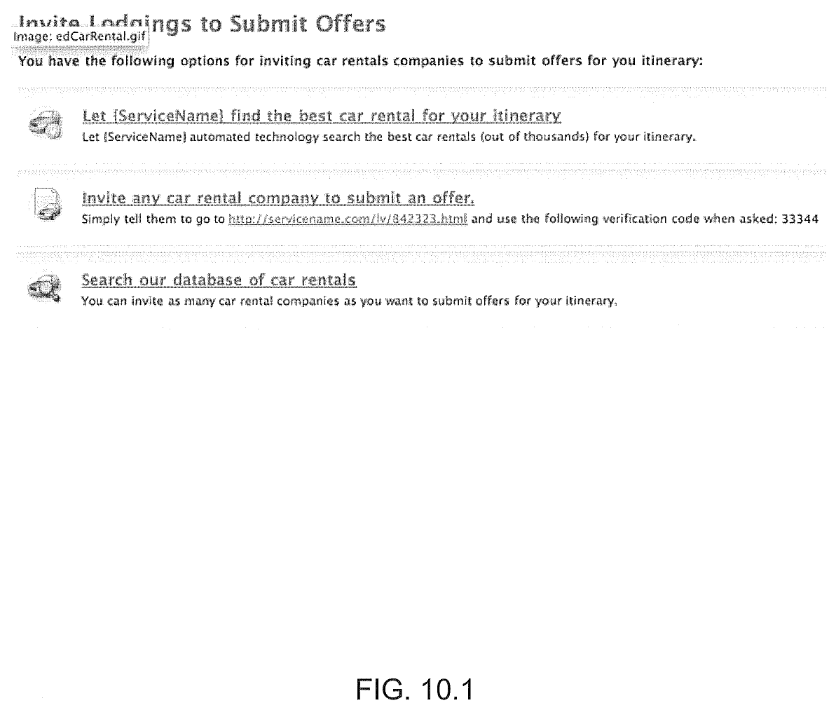

The flow chart of FIG. 10 depicts an embodiment of the method of the invention in which the buyer, during or after the defining and submitting of a request at step 220 of FIG. 2, can allow the system 10 to determine the sellers that should be invited to define and submit offers for the request, can search for sellers or services recorded in the database 134 and invite one or more of those sellers to submit offers for the request, and/or can receive instructions from the application server 100 to forward to potential sellers.

FIG. 10.1 illustrates a user interface generated by the buyer application component 120 in which a buyer is provided with several links to learn about the various options available to invite sellers and potential sellers to submit offers for a car-rental-related request. The buyer is provided with three options. The first option allows the server to do the matching as per the general embodiment discussed above. The second option provides the buyer with instructions that the buyer should provide to sellers that the buyer wishes to invite. The third option invites the buyer to search the database 134 for car rental services.

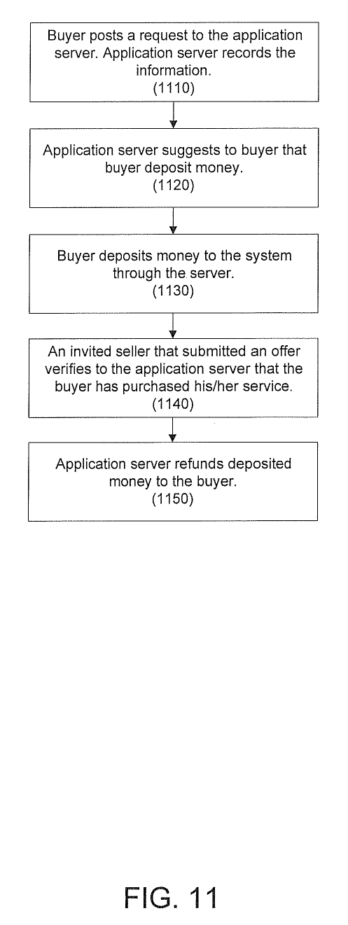

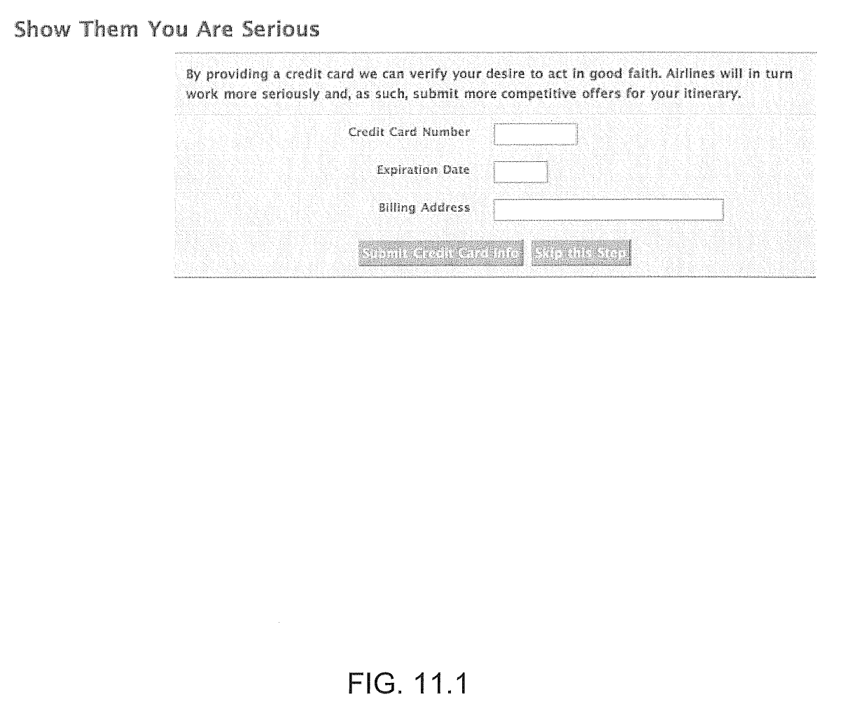

The flow chart of FIG. 11 depicts an embodiment of the method of the invention in which the buyer, at step 220 of FIG. 2, is able to demonstrate his/her willingness to buy a service from among the offers that he/she will receive for a given request. It is anticipated that allowing buyers to show a willingness to purchase a service will motivate invited sellers to submit more and better offers for a given request. The buyer may show this willingness to purchase a service by depositing money to the system 10 or a third party through the server 100, paying a fee to the system 10, providing a credit card number, submitting a conditional purchase order, and/or providing some other verification means to the system 10. Fees deposited by the buyer are optionally refunded in the event that the buyer successfully reserves, buys, or uses one of the services offered by one of the invited sellers. At block 1110, a buyer submits a request. At block 1120, the application server 100, through the buyer application component 120, suggests that the buyer deposit money through the application server 100 as a way of showing his/her willingness to buy a service from one of the offers that the buyer will receive. At block 1130, the buyer deposits money through the application server 100. At block 1140, an invited seller who submitted an offer verifies to the application server 100 that the buyer has purchased his/her service. At block 1150, the application server 100 returns the deposited money to the buyer.

FIG. 11.1 illustrates a user interface generated by the buyer application component 120 that allows a buyer to provide credit card information to verify the buyer's desire to act in good faith. It is anticipated that supplying this information will result in the buyer receiving more competitive offers for a given request.

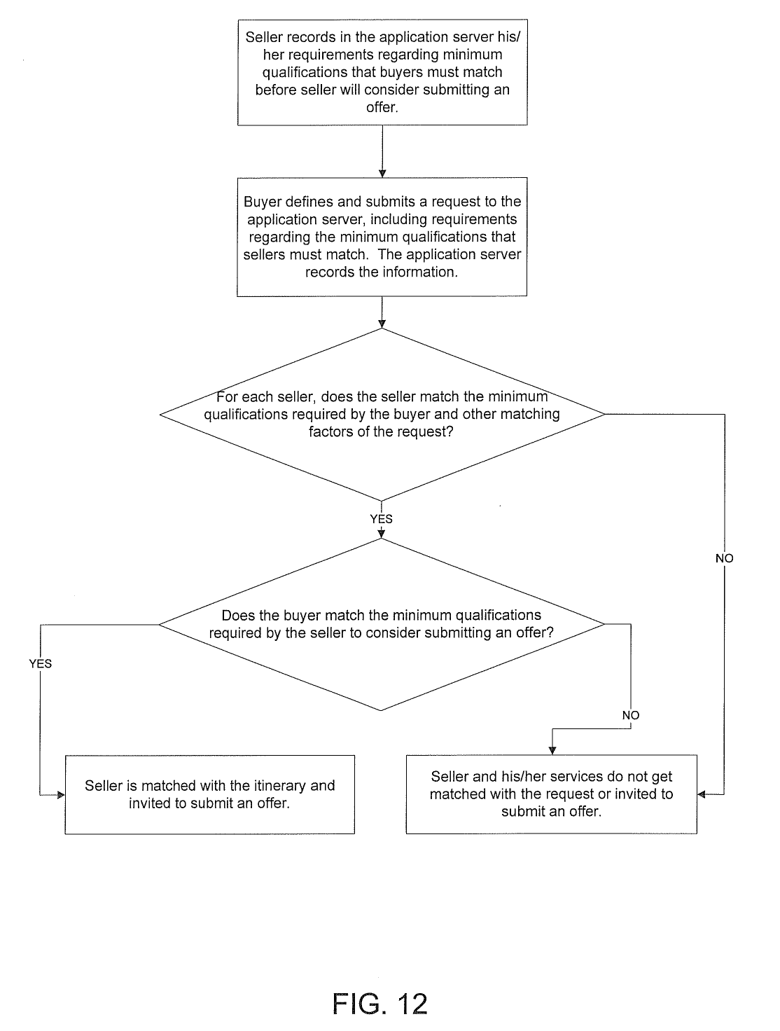

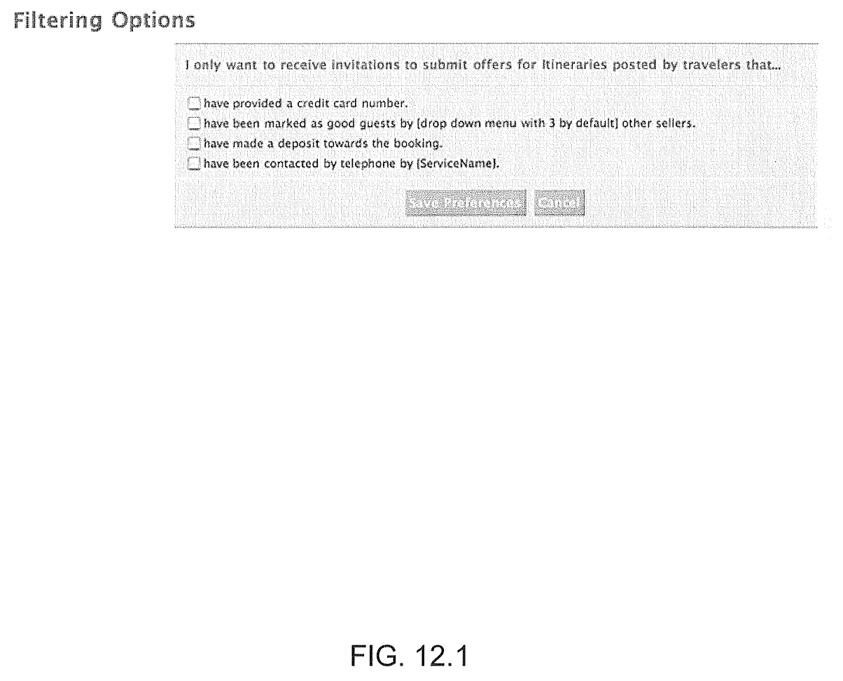

The flow chart of FIG. 12 depicts an embodiment of the method of the invention in which, at step 220 of FIG. 2, buyers can specify the minimum qualifications that a seller should have in order to be invited to submit an offer for his/her request, and, during the registration of sellers (discussed with respect to FIG. 2.2), sellers can specify the minimum qualifications that a buyer should have in order for the seller to be invited to submit an offer for a request posted by the particular buyer. For example, a buyer who defines and submits a car-rental request may require that only sellers who match certain criteria be invited to submit offers for the request. The criteria, in addition to other factors, could include the requirement that the sellers have received reviews from ten or more buyers registered with the system 10, and that at least 90% of the reviews were positive. In another example, a seller offering lodging services could specify that he/she should only be invited to submit offers for lodging-related requests posted by buyers that have ten or more “friends” in the social network of the system 10, have been registered with the system 10 for at least three years, or have been added as “contacts” of the seller. For example, buyers and sellers may be given the option of being matched based on social network factors, such as the number of users (other buyers or sellers) that have marked the buyer or seller as a “friend” or “contact,” the feedback rating or ranking given to the buyer or seller by other users, etc. It is expected that this embodiment will take advantage of social networks and marketplace feedback in the system 10, and allow sellers to adjust their offers and prices, and buyers to make their selection decisions, based in part on the historical and potential reliability of the buyers and sellers. It is anticipated that buyers will be able to make smarter decisions by taking into account statistics and information that have not been previously been used and/or available by buyers of travel-related services in selecting a seller. Additionally, it is anticipated that sellers will be able to adjust their prices and offers for different buyers depending on the historical data of each buyer in the database 134. For example, the prices offered to a buyer who has received good reviews by other sellers might be lower than those received by other average buyers. Thus, it is anticipated that the buyer will have a more attractive, effective, and dynamic way to find sellers of travel-related services, and that the seller will have a more attractive, effective, and dynamic way of selling his services than the prior-art currently allows.

FIG. 12.1 illustrates a user interface generated by the seller application component 122 that allows a seller to specify the minimum qualifications that a buyer should have in order for the seller to be invited to submit an offer for a request defined and submitted by the buyer.

It is anticipated that the embodiments discussed herein may apply to numerous types of itineraries and offers for a wide array of categories, including, but not limited to, the following examples.

An exemplary request for sleeping accommodations defined and submitted by a buyer might include the following requirements:
Five nights lodging
Arrive May 13th or 14th
Depart May 16th or 17th
Within 15 minutes walk time from the White House, Washington, D.C.
Two double beds or two larger size beds
Four people total
At least one room
Non-smoking
Lodging could be a guest room at a hotel, an apartment, or a room at a hostel

An exemplary request for sleeping accommodations defined and submitted by a buyer might include the following requirements:
Four to six nights
Any time in June, July, or August
Anywhere in the world
Lodging should offer ski-in and out (lodging is within walking access of a ski track)
One king bed
Two people
Pet friendly
Lodging could be a resort, hotel, lodge, bed & breakfast, apartment, bungalow, chalet, or cabin.
Heated pool preferred, but not required.
10 sellers have positively rated the buyer during the past two years.
1 seller has negatively rated the buyer during the past two years.

An exemplary request for a tour defined and submitted by a buyer might include the following requirements:
July 31^{st} in the afternoon or August 1^{st} in the morning.
Pick up in or nearby 456 W, 42^{nd} Street, New York, N.Y.
Two people
Tour should be a sightseeing tour
Tour could be a motorized terrestrial tour, boat tour, or walking tour
Special request: tour should include visit to Chinatown

An exemplary request for airline tickets defined and submitted by a buyer might include the following requirements:
Four adults
One child under two years of age
From New Orleans to any airport in the Washington D.C. area
One way
Departing December 1^{st} or 2^{nd} between 8 PM and 11 PM.
One stop is acceptable if the layover is less than 2 hours.
All seats should recline
All four passengers should be seated in the same row
Maximum budget is $130.00 per ticket, including all fees and taxes.
Tickets should be 100% refundable.

Another exemplary request for airline tickets defined and submitted by a buyer might include the following requirements:
One adult
Departing anytime tomorrow
Returning after three or four days
From Montreal, Canada, to anywhere in Western Europe.
Non-stop flights only
Business class or first class
Organic meal preferred, but not required
Tickets may not be refundable or exchangeable
The buyer has 121 friends in the social network of the system
The buyer registered with the system 5 months and 4 days ago
The buyer has successfully purchased a service offered in response to the buyer'submitted itineraries 80% of the time
The buyer was telephoned by agents of the system to verify the legitimacy of this request.

An exemplary request for a car rental defined and submitted by a buyer might include the following requirements:
Any mid-size car or larger
Pick up in Shanghai International Airport on November 28^{th} around noon
Return to Downtown Beijing, China on December 7^{th} at night
Car should have a mileage of 30 MPG or better
European car preferred, but not required
Full insurance should be included in price
Maximum budget is $50.00 per day
The system has verified that the driver has a flawless driving record in the US
Driver credit score in the US is 760 points

An exemplary request for cruises defined and submitted by a buyer might include the following requirements:
Destination is Alaska or the Mediterranean
Departing between June 8^{th} and June 15^{th}
Length of trip is between 5 nights and 8 nights
Group of 43 adults
One bed per person required
No more than two people per cabin
No inside cabins
The buyer has deposited $500.00 toward the purchase of the service
Special Request: conference facilities required

An exemplary request for a vacation package defined and submitted by a buyer might include the following requirements:
Flight, hotel, and car required
Departing from Baltimore, Md.
Traveling to Big Island, Hi.
Departing October 4^{th} in the morning and returning October 9^{th} at night
2 seniors and 1 child
2 rooms

An additional exemplary request for a vacation package defined and submitted by a buyer might include the following requirements:
Flight and hotel required
Departing from Bogota, Colombia
Departing any Friday or Saturday between August 1^{st} and August 20^{th}
Staying two or three nights in Buenos Aires, Argentina
Traveling from Buenos Aires, Argentina, to Montevideo, Uruguay, by air, bus, or boat.
Staying in Montevideo, Uruguay three or four nights
Flying back from Montevideo, Uruguay to Bogota, Colombia
All flights should be non-stop
4 adults
2 rooms
One queen bed or larger in each room
Lodgings should be four star hotels or better
Flights should not be red-eye
Reservation may not be refundable
Seller should have a rating of 95% or higher (95% of all reviews given by other buyers for the sellers should be positive)
Buyer's credit card has been verified by the system
Buyer has paid a $25.00 verification fee to the system
Buyer posted two requests in the past

An exemplary request for a travel related activity defined and submitted by a buyer might include the following requirements:
Activity required: Golf
Activity must be less than a 60 minute drive time from downtown Miami, Fla.
2 adults
February 23^{rd} at 9:00 AM
Payment upon completion of the activity

The invention provides a more attractive, effective, and dynamic way for buyers to find sellers of travel-related services, and for sellers to sell their travel-related services to buyers. It is contemplated that the method and system of the invention could also be built as an application for a social network, such as Facebook.com, or for a specialized market, such as last-minute travel, luxury vacation rentals, or independent sellers. The communication channels used between the web server, the buyer, and the seller could be replaced by any other communication channel. For example, the buyer could post a request by visiting a local store where a clerk receives all of the information of the request by asking questions to the buyer face-to-face. Alternatively, the seller could submit offers by sending a text message from his mobile phone. The buyer could receive offers, after submission by sellers, via fax. The method and system could be built as an invitation-only system where only invited buyers and sellers can participate, and/or in an intranet with no access to and from the Internet. The method and system could be built as a marketplace where several sellers can work in conjunction to fulfill the requirements of one request posted by a buyer. The method and system could benefit from allowing buyers to share their requests with other buyers, which could allow buyers to gain negotiating power by joining together. The method and system can easily be adapted to handle new types of travel not disclosed in this document or currently known. The method and system can be built as an exchange where travel-services are bought and sold as shares in a stock market.

The method and system could allow sellers to submit proxy prices attached to their offers. For example, a seller could ask the application server to submit an offer for $700.00 with a minimum proxy price of $500.00. The application server would monitor for new incoming offers. If a new incoming offer has a price below $700.00, then the application server could automatically resubmit a new offer from the seller with a new price. This feature would allow sellers to even more proactively compete for the itinerary of a buyer.

There have been described and illustrated herein several embodiments of a method and system for facilitating the selection of sellers offering travel related services. While particular embodiments of the invention have been described, it is not intended that the invention be limited thereto, as it is intended that the invention be as broad in scope as the art will allow and that the specification be read likewise. Thus, while particular application server architectures have been disclosed, it will be appreciated that other architectures for web-based services can be used as well. In addition, while particular data have been disclosed for matching buyer requests with sellers and seller services and offers, it will be understood that the method and system as described herein can be used for other applications, including, and not by way of limitation, systems for matching employers to potential employees, systems for matching corporate buyers to potential vendors and other suitable reverse auction processes. Moreover, while particular methodologies have been disclosed in reference to the generation of a flow control process and likelihood index or ranking, it will be appreciated that other methodologies could be used as well. It will therefore be appreciated by those skilled in the art that yet other modifications could be made to the provided invention without deviating from its spirit and scope as claimed.

1. A method for facilitating transactions between sellers and buyers for travel related services, comprising:
(a) providing a database that stores data associated with a plurality of sellers, the data representing, for each respective seller, i) at least one geographical reference and ii) travel-related services offered by the respective seller at the at least one geographical reference;
(b) providing a server that is capable of interaction with buyers over a communication network, the server operably coupled to the database;
(c) a buyer interacting with the server to define and submit a request, the request specifying at least one geographical reference and at least one travel related service;
(d) in response to submission of said request, initiating an automatic process on the server that analyzes said database to select a set of sellers that match said request; and
(e) automatically communicating a message from the server to at least one seller of the set of sellers selected in (d), the message including an invitation for submission of at least one offer corresponding to said request.

2. The method according to claim 1, further comprising:
(f) receiving at the server at least one offer corresponding to said request and communicated from a seller to whom an invitation was communicated in (e).

3. The method according to claim 1, wherein:
said providing of said database in step (a) includes inputting into said database information associated with at least one seller, said inputting done manually or automatically.

4. The method according to claim 1, wherein:
said request includes at least one of an originating city, a destination city, an arrival date, and a return date.

5. The method of claim 1, wherein:
said request includes at least one of a number ‘i’ and a special instructions entry, ‘i’ representing the number of people traveling.

6. The method of claim 1, wherein:
said request includes at least one ideal traveling date and at least one second choice traveling date.

7. The method of claim 1, wherein:
said defining and submitting of said request in (c) includes selecting at least one category of said travel related services represented in said data.

8. The method of claim 7, wherein:
said at least one category includes at least one of lodging, air travel, ground transportation, tours, cruises, vacation packages, and activities.

9. The method of claim 2, further comprising:
repeating (d), (e), and (f) during a bidding process on the server.

10. The method of claim 9, wherein:
during said bidding process, a given seller of said at least one seller to whom invitations were communicated in (e) may view all offers submitted to the server corresponding to said request.

11. The method of claim 9, wherein:
said bidding process includes a number of processing cycles.

12. The method of claim 9, wherein:
said bidding process is an on-line auction.

13. The method of claim 2, further comprising:
(g) communicating the at least one offer received at the server in (f) to said buyer.

14. The method of claim 13, wherein:
said communicating in (g) includes presenting to said buyer a single graphical user interface that enables said buyer to compare all offers received at the server and corresponding to said request.

15. The method of claim 13, further comprising:
(h) providing said buyer with the ability to interact with said server to select a particular offer received at the server in (f).

16. The method of claim 15, further comprising:
(i) facilitating a transaction through the server between said buyer and the seller of the particular offer selected in (h).

17. The method of claim 15, further comprising:
(j) providing said buyer with identity and contact information for the seller of the particular offer selected in (h).

18. The method of claim 1, wherein:
said communicating in (e) includes sequentially inviting said at least one seller to submit offers until said buyer has received a predetermined number of offers.

19. The method of claim 18, wherein:
said predetermined number of offers is a fixed value.

20. The method of claim 18, wherein:
said buyer determines the predetermined number of offers.

21. The method of claim 1, wherein:
said communicating in (e) includes notifying and inviting said at least one seller to submit additional offers when at least one of the following occurs:
(i) a new offer is submitted to said server and
(ii) an existing offer corresponding to said request is modified.

22. The method of claim 1, wherein:
said automatic process in (d) includes employing a sequence criteria to select said set of sellers that match said request.

23. The method of claim 22, wherein:
said automatic process in (d) includes assigning a corresponding rank to each seller of the set of sellers that match said request, said corresponding rank calculated from at least one relevancy index.

24. The method of claim 23, wherein:
said communicating in (e) includes utilizing the corresponding rank of each seller of the set of sellers to determine which of the set of sellers to first invite to submit offers.

25. The method of claim 23, wherein:
said communicating in (e) includes inviting said set of sellers in order of corresponding rank.

26. The method of claim 23, wherein:
said at least one relevancy index includes at least one of an originating city index, a destination city index, an arrival date index, and a return date index.

27. The method of claim 23, wherein:
said at least one relevancy index includes a party number index.

28. The method of claim 23, wherein:
said at least one relevancy index includes a special instructions index.

29. The method of claim 23, wherein:
said at least one relevancy index includes a travel dates index.

30. The method of claim 23, wherein:
said at least one relevancy index includes at least one price index.

31. The method of claim 23, wherein:
said at least one relevancy index includes a travel services index.

32. The method of claim 31, wherein:
said travel services index includes at least one of an air travel index, a gound transportation index, a lodging index, a tours index, a cruises index, and a vacation packages index.

33. The method of claim 31, wherein:
said relevancy index includes a minimum qualifications index for sellers.

34. The method of claim 31, wherein:
said relevancy index includes a minimum qualifications index for buyers.

35. The method of claim 31, wherein:
said relevancy index includes a feedback rating index for sellers.

36. The method of claim 31, wherein:
said relevancy index includes a feedback rating index for buyers.

37. The method of claim 1, wherein:
said communicating in (e) includes said buyer selecting and inviting other sellers from said database to submit offers through said server corresponding to said request.

38. The method of claim 1, wherein:
said communicating in (e) includes said buyer inviting additional sellers not listed in said database to submit offers through said server corresponding to said request.

39. The method of claim 1, wherein:
said receiving in (f) includes a given seller invited in (e) linking an existing offer in said database corresponding to a different request to the request submitted by said buyer, whereby said given seller may submit said existing offer for consideration with regard to multiple requests submitted by one or more buyers.

40. The method of claim 1, wherein:
said defining and submitting of said request in (c) includes said buyer selecting information corresponding to said buyer to hide from a given seller.

41. The method of claim 13, wherein:
said communicating in (g) includes hiding information concerning the seller of the particular offer communicated to the buyer in (g) from the buyer.

42. The method of claim 1, wherein:
said submitting of said request in (d) includes said buyer providing credit card information with said request.

43. The method of claim 1, wherein:
said submitting of said request in (d) includes said buyer depositing a fee through said server.

44. The method of claim 43, wherein:
said fee is refundable to said buyer.

45. The method of claim 1, wherein:
said submitting of said request in (d) includes said buyer submitting a conditional purchase order.

46. The method of claim 1, wherein:
said buyer is an agent representing a third party purchaser.

47. The method of claim 1, wherein:
a given seller of said plurality of sellers in said database may select a matching option whereby said given seller is matched with at least one buyer based on criteria specified by said given seller and on at least one likelihood index corresponding to said at least one buyer.

48. An apparatus for facilitating transactions between sellers and buyers for travel related services, the transactions related to a request, the apparatus comprising:
a database that stores data associated with a number of sellers, the data representing, for each respective seller, i) at least one geographical reference and ii) travel-related services offered by the respective seller at the at least one geographical reference;
means for interacting with a buyer over a communication network to specify said request and store data related to said request in said database;
logic that performs an automated process for selecting a set of sellers that match said request from said number of sellers stored in said database;
means for communicating with said set of sellers and inviting said set of sellers to submit offers corresponding to said request; and
means for receiving offers from said set of sellers corresponding to said request and storing said offers in said database;

49. The apparatus of claim 48, further comprising:
means for communicating the offers corresponding to said request and received from said set of sellers to said buyer.

50. The apparatus of claim 49, wherein:
said means for interacting with said buyer over the communication network to specify said request includes said buyer indicating a target number of offers that said buyer wishes to receive in response to said request, and
wherein the number of sellers selected to form said set of sellers is determined from said target number.

51. The apparatus of claim 49, wherein:
said request includes at least one requirement, and said logic that performs said automated process calculates a rank corresponding to each seller in said set of sellers, said rank based on a similarity analysis between said at least one requirement of said request and the data that is associated with each seller of said set of sellers stored in said database.

52. The apparatus of claim 51, wherein:
said means for communicating with and inviting said set of sellers includes a bidding process conducted on said communication network.

53. The apparatus of claim 48, further comprising:
means for presenting to said buyer said offers received from said set of sellers corresponding to said request.

54. The method of claim 23, wherein:
said relevancy index includes a commissions index for sellers.

55. The method of claim 13, wherein:
said communicating in (g) includes hiding information concerning the seller of the particular offer communicated to the buyer in (g) from other of said set of sellers selected in (d).

56. The method of claim 1, wherein:
said request includes at least one flexible traveling date.

57. The method of claim 1, wherein:
said at least one geographical reference includes at least one of a city, a zip code, an airport code, a landmark, an event, a latitude, a longitude, and a radial distance.
